(19) United States
(12) Patent Application Publication
(10) Pub. No.: US 2026/0313265 A1
(43) Pub. Date: Oct. 8, 2026

(54) IMAGE SENSOR INCLUDING AVALANCHE PHOTODIODE

(71) Applicant: Samsung Electronics Co., Ltd., Suwon-si (KR)

(72) Inventors: Takashi KUSAKARI, Yokohama (JP); Toshinori OTAKA, Yokohama (JP)

(73) Assignee: Samsung Electronics Co., Ltd., Suwon-si (KR)

(21) Appl. No.: 19/638,514

(22) Filed: Apr. 3, 2026

(30) Foreign Application Priority Data
Apr. 7, 2025 (JP) 2025-062894

(51) Int. Cl. H04N 25/773

(52) U.S. Cl. CPC H04N 25/773

(57) ABSTRACT

An image sensor includes an avalanche photodiode including an anode and a cathode, a charging circuit configured to recharge the anode or the cathode once per unit exposure time, an in-pixel counter configured to count a pulse signal, an intermediate image generator configured to generate a plurality of intermediate images by accumulating, over a plurality of unit exposure times, values counted by the in-pixel counter, and a frame image generator configured to calculate, by using one of the plurality of intermediate images generated in a time series as a reference intermediate image, a difference vector for each pixel with respect to the reference intermediate image for each of at least one non-reference intermediate image other than the reference intermediate image, and generate a frame image by adding, to the reference intermediate image, the at least one non-reference intermediate image corrected based on difference vectors corresponding to each pixel.

### CROSS-REFERENCE TO RELATED APPLICATION

This application is based on and claims priority under 35 U.S.C. § 119 to Japanese Patent Application No. 2025-062894, filed on Apr. 7, 2025, in the Japanese Patent Office, the disclosure of which is incorporated herein by reference in its entirety.

### BACKGROUND

Some example embodiments of the disclosure relate to an image sensor configured to improve an effect of suppressing or reducing motion blur in an image captured using a single-photon avalanche diode (SPAD), regardless of the speed of a moving object being captured.

Image sensors (photoelectric conversion devices) use SPADs. A SPAD utilizes avalanche multiplication in which a relatively larger number of carriers are generated when a single photon is incident on a PN junction of an avalanche photodiode (APD) to which a reverse bias exceeding a breakdown voltage is applied. An image sensor using SPADs may include an APD in each of a plurality of pixels arranged in a row direction and a column direction. The image sensor using SPADs captures images by counting pulses generated based on signals of carriers produced by the avalanche multiplication in the APDs.

Motion blur or the like of a moving object in a moving image captured by an image sensor may be corrected by correcting frame images of the moving image based on the amount of variation in the moving object between the frame images.

### SUMMARY

The processing operation in a comparative example may calculate a camera trajectory or interpolation of intermediate frame images based on frame images, and may be a relatively complicated operation. In addition, it may be challenging to reduce motion blur caused by charge accumulation corresponding to an exposure time for a relatively fast-moving object. In another comparative example, motion blur may become relatively large depending on the speed of a moving object being captured.

Example embodiments of the disclosure provide an image sensor configured to reduce or suppress motion blur in an image captured using a single-photon avalanche diode (SPAD), regardless of the speed of a moving object being captured.

An image sensor according to some example embodiments includes an avalanche photodiode including an anode and a cathode, a charging circuit configured to recharge the anode or the cathode once per unit exposure time, a gating circuit configured to generate a pulse signal based on an output of the avalanche photodiode at a plurality of timings within the unit exposure time, an in-pixel counter configured to count the pulse signal, an intermediate image generator configured to generate a plurality of intermediate images by accumulating, over a plurality of unit exposure times, values counted by the in-pixel counter, and a frame image generator configured to calculate, by using an intermediate image of the plurality of intermediate images generated in a time series as a reference intermediate image, a difference vector for each pixel with respect to the reference intermediate image for each of at least one non-reference intermediate image other than the reference intermediate image, and generate a frame image by adding, to the reference intermediate image, the at least one non-reference intermediate image corrected based on difference vectors corresponding to each pixel.

An image sensor according to some example embodiments includes a pixel array including a plurality of pixels each including an avalanche photodiode, a data accumulator configured to generate a plurality of subframe images including a first subframe image and a second subframe image by accumulating count values of pixel data from the pixel array for each unit exposure time, and a signal processor configured to generate a frame image by processing the plurality of subframe images, wherein the signal processor is configured to calculate difference vectors for the second subframe image with respect to the first subframe image as a reference, generate a corrected second subframe image by applying the difference vectors to the second subframe image, and generate the frame image by adding the corrected second subframe image to the first subframe image.

An image sensor according to some example embodiments includes a pixel array including a light-receiving unit including an avalanche photodiode, and a pixel circuit, a data accumulator configured to generate a plurality of subframe images by accumulating count values of pixel data from the pixel array for each unit exposure time, and a signal processor configured to generate a frame image by processing the plurality of subframe images, wherein the signal processor is configured to determine an increase or a decrease in a subsequent subframe rate based on a parameter related to difference vectors calculated by comparison between some of the plurality of subframe images.

### BRIEF DESCRIPTION OF THE DRAWINGS

Embodiments of the inventive concept will be more clearly understood from the following detailed description taken in conjunction with the accompanying drawings in which:

FIG. 1 is a schematic block diagram illustrating a configuration of an image sensor, according to some example embodiments.

FIG. 2 is a functional block diagram illustrating a function of a pixel shown in FIG. 1, according to some example embodiments.

FIG. 3 is a conceptual diagram illustrating a time aperture imaging algorithm, according to some example embodiments.

FIG. 4 is a diagram illustrating an information amount regarding the number of photons per recharge according to a sensitivity channel used, according to some example embodiments.

FIG. 5 is a schematic diagram illustrating a concept model of incident photon detection using a time aperture imaging algorithm for realizing a plurality of sensitivities, according to some example embodiments.

FIG. 6 is a diagram illustrating count values according to levels of illuminance, according to some example embodiments.

FIG. 7 is a diagram illustrating dynamic range expansion ratios and the number of bits of an in-pixel counter, corresponding to various combinations of time aperture ratios for sensitivity channels, according to some example embodiments.

FIG. 8 is a schematic diagram illustrating a data accumulator that reconstructs an image based on pixel data, according to some example embodiments.

FIG. 9 is a circuit diagram illustrating a case where hardware of a pixel is configured with a two-layer substrate, according to some example embodiments.

FIG. 10 is a timing chart illustrating an operation of a pixel circuit shown in FIG. 9, according to some example embodiments.

FIG. 11 is a schematic block diagram illustrating a configuration of a signal processor shown in FIG. 1, according to some example embodiments.

FIG. 12 is a block diagram illustrating a hardware configuration of a signal processor, according to some example embodiments.

FIG. 13 is an explanatory diagram illustrating an operation of a signal processor, according to some example embodiments.

FIG. 14 is a flowchart illustrating operations of a signal processor, according to some example embodiments.

FIG. 15A is an explanatory diagram illustrating a process of increasing a subframe rate when the magnitude of a difference vector is large, according to some example embodiments.

FIG. 15B is an explanatory diagram illustrating a process of decreasing a subframe rate when the magnitude of a difference vector is small, according to some example embodiments.

FIG. 16 is a flowchart illustrating operations of a signal processor, according to some example embodiments.

FIG. 17 is a schematic block diagram illustrating a configuration of a signal processor and a region of interest (ROI) data accumulator, according to some example embodiments.

FIG. 18 is an explanatory diagram illustrating an ROI according to some example embodiments.

FIG. 19 is a flowchart illustrating operations of a signal processor, according to some example embodiments.

FIG. 20 is a flowchart illustrating operations of a signal processor, according to some example embodiments.

FIG. 21A is an explanatory diagram illustrating a process of increasing a subframe rate when at least one of the number and density of difference vectors having periodicity is large, according to some example embodiments.

FIG. 21B is an explanatory diagram illustrating a process of decreasing a subframe rate when at least one of the number and density of difference vectors having periodicity is small, according to some example embodiments.

FIG. 22 is a flowchart illustrating operations of a signal processor, according to some example embodiments.

FIG. 23 is a schematic block diagram illustrating a configuration of a signal processor, according to some example embodiments.

FIG. 24A is an explanatory diagram illustrating estimation of an ROI, according to some example embodiments.

FIG. 24B is an explanatory diagram illustrating control of a subframe rate based on difference vectors corresponding to pixels inside an ROI, according to some example embodiments.

FIG. 25 is a schematic block diagram illustrating a configuration of an image sensor, according to some example embodiments.

FIG. 26 is a diagram illustrating an example of a frame image captured at night, according to some example embodiments.

### DETAILED DESCRIPTION OF THE EMBODIMENTS

Hereinafter, an imaging device and an imaging program according to some example embodiments will be described in detail with reference to the drawings. The example embodiments described herein are only an example, and various modifications may be made to the example embodiments. Hereinafter, in the drawings, like reference numerals denote like elements, and the sizes of the elements in the drawings are illustrated at ratios different from actual ratios for clarity and convenience of description.

Hereinafter, expressions such as “upper” or “above” include not only those that are in direct contact and located above, below, left, or right, but also those located above, below, left, and right without contact.

The terms, such as “first”, “second”, etc., are used herein to describe various elements or components, but are used only for the purpose of distinguishing one element from another. Such terms do not limit materials and structures of the elements as being different from each other.

An element described in a singular form includes a plurality of components, unless the context clearly indicates otherwise. Furthermore, when a part “includes” or “comprises” an element, unless there is a particular description contrary thereto, it is understood that the part may further include other elements, not excluding the other elements.

Furthermore, terms such as “unit,” “module,” etc. used herein indicate a unit for processing one or a plurality of functions or operations and may be implemented as hardware or software or a combination of hardware and software.

In addition, the term “pixel” may refer to a minimum unit constituting an image, or hardware for detecting data of the minimum unit constituting the image.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

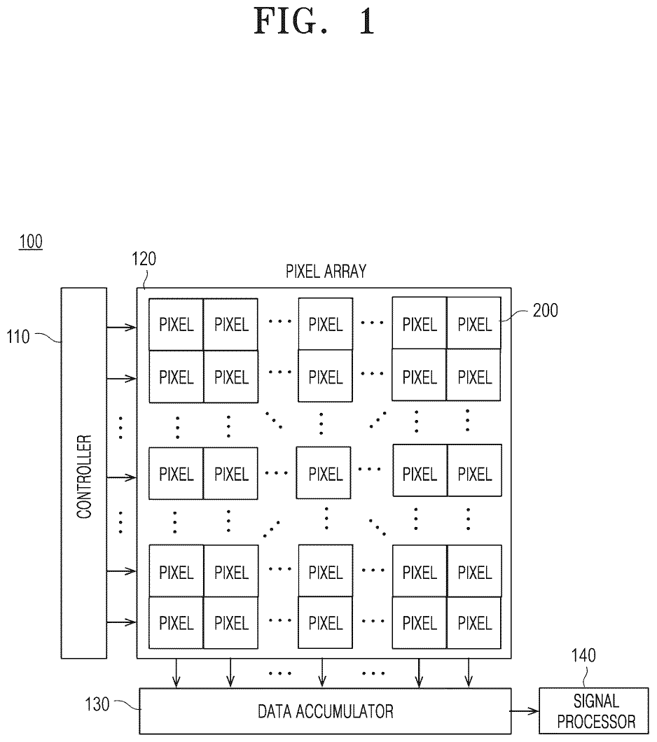

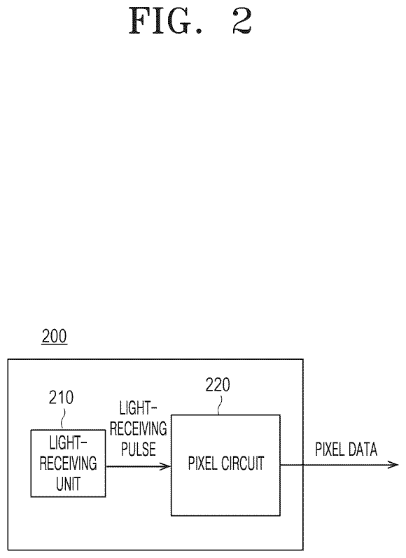

FIG. 1 is a schematic block diagram illustrating a configuration of an image sensor 100, according to some example embodiments. FIG. 2 is a functional block diagram illustrating a function of a pixel 200 shown in FIG. 1.

As illustrated in FIG. 1, the image sensor 100 includes a controller 110, a pixel array 120, a data accumulator 130, and a signal processor 140. The data accumulator 130 may include an intermediate image generator. The signal processor 140 may include or be configured as a frame image generator.

The controller 110 may control the pixel array 120 by supplying various signals to the pixel array 120. The controller 110 may generate or input various signals such as clock signals and control signals. The control signals may include, for example, a reset bar (RSTB) signal, a charging signal, a selection (SEL) signal, and a check (CHK) signal, and details of these various signals are described below.

The pixel array 120 may include a plurality of pixels 200 (e.g., M pixels) arranged in a two-dimensional grid (in row and column directions) in a plan view from a direction perpendicular to a substrate surface of the image sensor 100. Here, M is a natural number of 2 or more.

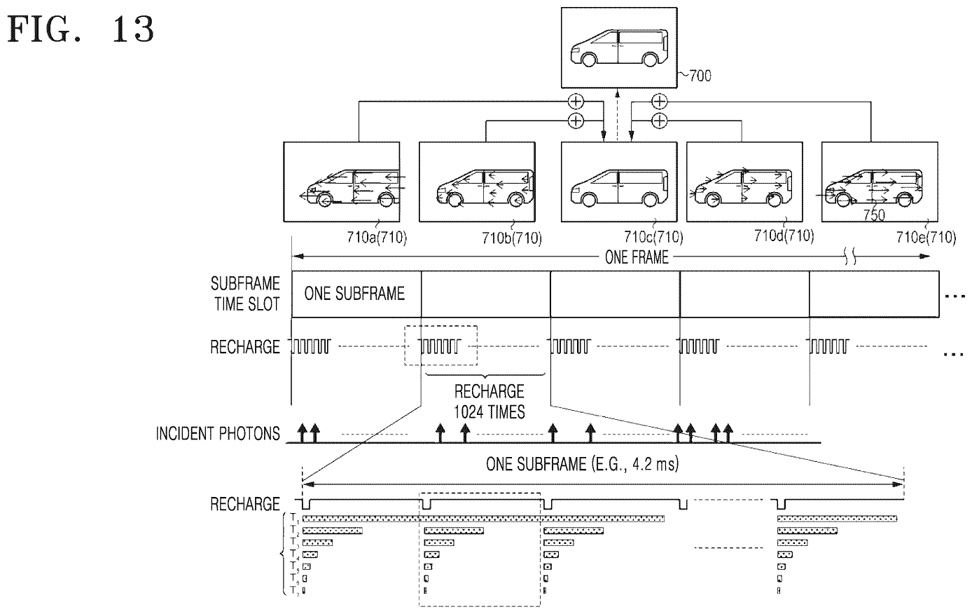

The data accumulator 130 may generate a subframe image (710 of FIG. 13) by accumulating, over a plurality of unit exposure times, count values of pixel data from the pixel array 120 for each unit exposure time. The subframe image 710 constitutes an intermediate image. The subframe image 710 is described below.

The signal processor 140 may perform predetermined or desired image processing on the subframe image 710 from the data accumulator 130 and output a frame image (700 of FIG. 13) as a processing result. The image processing may include calculating a difference vector (750 of FIG. 13) and generating the frame image 700 by using the subframe image 710 and the difference vector 750, as described below.

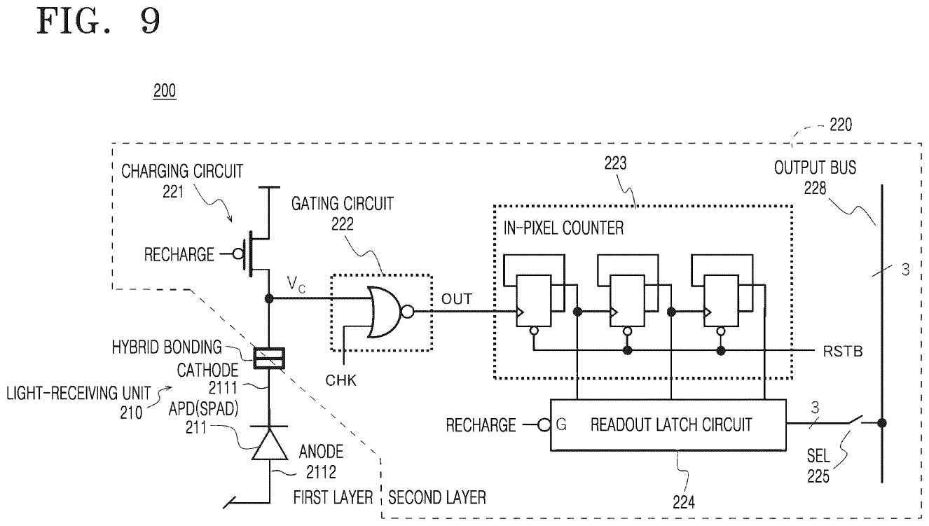

As illustrated in FIG. 2, the pixel 200 includes a light-receiving unit 210 and a pixel circuit 220. Because an avalanche photodiode (APD) is used as a light-receiving element in the disclosure, the pixel 200 is also referred to as a single-photon avalanche diode (SPAD) pixel. The light-receiving unit 210 may include an APD (211 of FIG. 9). The APD 211 may also be referred to as an avalanche photodiode. As illustrated in FIG. 9, the pixel circuit 220 may include a charging circuit (a charging unit) 221, a gating circuit (a gating unit) 222, an in-pixel counter (a counting unit) 223, a readout latch circuit (a latch unit) 224, a selection circuit (hereinafter also referred to as a “SEL”) 225, an output bus 228, and the like.

Referring briefly to FIG. 9, the charging circuit 221 recharges a cathode 2111 of the APD 211 once per unit exposure time in response to a charging signal received from the controller 110. According to some example embodiments, the unit exposure time is a time from when a recharge is performed until a subsequent recharge is performed. The unit exposure time is a constant time regardless of the amount of incident light. One charging period is referred to as an exposure time unit. In some example embodiments, one subframe is a set of a plurality of exposure time units. The charging signal is a one-shot trigger signal with a period (e.g., 4 μs) corresponding to the unit exposure time. In some example embodiments, an anode 2112 of the APD 211 is set to a fixed potential and the cathode 2111 of the APD 211 is recharged. As a result, a potential difference between the anode 2112 and the cathode 2111 becomes a predetermined, desired, or given voltage at which the APD 211 is capable of operating in a Geiger mode. In some example embodiments, the potential difference, which is the sum of an avalanche breakdown voltage inherent to the device and an externally controllable excess voltage, is applied between the anode 2112 and the cathode 2111 of the APD 211. The cathode 2111 of the APD 211 is a terminal to which a potential higher than that of the anode 2112 of the APD 211 is applied, the anode 2112 of the APD 211 is a terminal to which a potential lower than that of the cathode 2111 of the APD 211 is applied, and the APD 211 operating in the Geiger mode may be referred to as a SPAD. According to some example embodiments, the configuration is not limited to setting the anode 2112 to a fixed potential, and alternatively, it may also be a configuration in which the cathode 2111 is at a fixed potential and the anode 2112 is recharged.

The gating circuit 222 generates a pulse signal based on an output of the APD 211 at a plurality of different timings of CHK signals within the unit exposure time. The timings of generation of the pulse signal and a specific hardware configuration of the gating circuit 222 are described below.

The in-pixel counter 223 detects and counts photons that are incident on one pixel 200 and contribute to occurrence of an avalanche operation by counting pulse signals from the gating circuit 222, and all photons incident on the pixel 200 do not necessarily contribute to the count. A hardware configuration of the in-pixel counter 223 is described below.

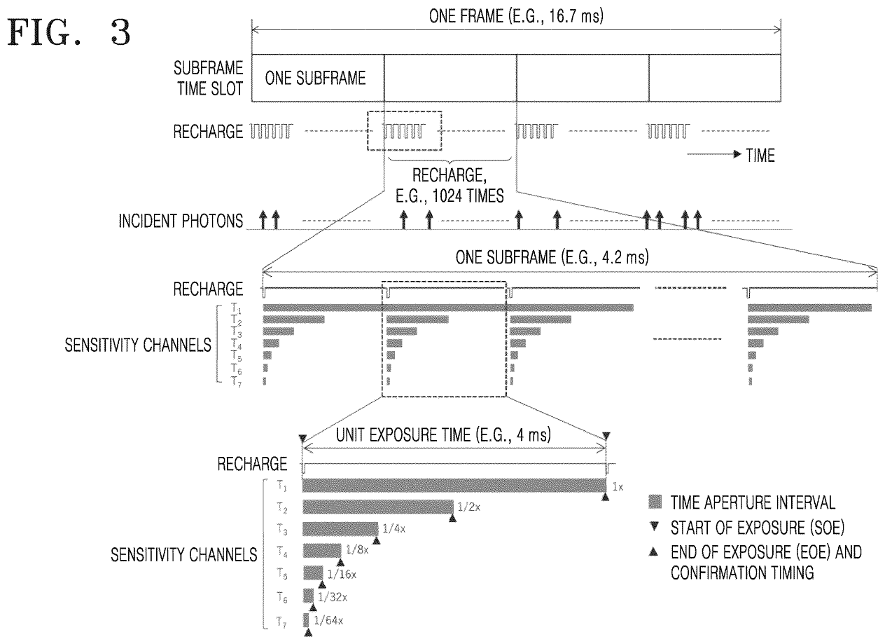

FIG. 3 is a conceptual diagram illustrating a time aperture imaging algorithm in the present embodiment. One frame includes a plurality of subframes. In an example shown in FIG. 3, one frame includes four subframes. When one frame (e.g., 16.7 ms) includes four subframes, one subframe corresponds to a period of about 4.2 ms. One subframe may include a plurality of exposure time units. FIG. 3 illustrates a case where 1024 exposure time units are included in one subframe. Accordingly, in this case, 1024 recharge operations are performed in the one subframe.

The number of photons reaching the APD 211 increases or decreases depending on an illuminance level, but an average arrival interval of photons at the APD 211 may follow an exponential distribution regardless of the illuminance level. Moreover, because photons arrive at the APD 211 randomly, there may be no bias in a probability density of a photon reaching the APD 211 at any time within a charging period. By using such randomness characteristics, a time aperture imaging algorithm may define an exposure time by using a time aperture. Therefore, a plurality of virtual sensitivity channels may be set within a single pixel.

In some example embodiments, a plurality of virtual sensitivity channels (hereinafter also referred to as sensitivity channels) Tᵢ (i=1, 2, . . . ) may be set for one exposure time unit. In FIG. 3, for each sensitivity channel Tᵢ, exposure starts at a “Start Of Exposure (SOE)” indicated by a black downward triangle (▾), and ends at an “End Of Exposure (EOE)” indicated by a black upward triangle (▴) The EOE also corresponds to a confirmation timing for photon detection. In some example embodiments, confirmation of photon detection is performed at the end of each of the plurality of virtual sensitivity channels Tᵢ. The controller 110 activates a CHK signal (determination signal) at a plurality of different timings of EOE for the respective sensitivity channels Tᵢ.

When a charging signal is low-active, exposure of each sensitivity channel Tᵢ starts at a timing when the charging signal becomes a low level (LO), and ends when a predetermined or desired time aperture interval for each sensitivity channel Tᵢ has elapsed from the start. Accordingly, the confirmation timings for photon detection may be different from each other. In addition, the SOE may occur simultaneously for all the sensitivity channels Tᵢ. In some example embodiments, exposure of the plurality of sensitivity channels Tᵢ is started at the same timing. Therefore, the time aperture intervals of the respective sensitivity channels Tᵢ may overlap with each other during a period (T₇ in FIG. 3) corresponding to the time aperture interval of the sensitivity channel with the lowest sensitivity from the SOE.

As described above, the image sensor 100 may include a plurality of virtual sensitivity channels Tᵢ having different time lengths within a unit exposure time. For the plurality of sensitivity channels Tᵢ, exposure starts at the same start timing and ends at different end timings, respectively, at which confirmation of photon detection is performed. The plurality of virtual sensitivity channels Tᵢ are configured such that any one virtual sensitivity channel includes another virtual sensitivity channel on a time axis.

FIG. 3 illustrates a case where seven sensitivity channels T₁ to T₇ are set. Hereinafter, a case where the sensitivity channels T₁ to T₇ or T₁ to T₃ are set is described as an example; however, the disclosure is not limited thereto. The sensitivity channel T₁ may be the highest sensitivity channel having a time aperture interval that is 1 times the unit exposure time. In some example embodiments, the sensitivity channel T₁ has sensitivity for detection (counting) of photons over a period equal to the unit exposure time. The sensitivity channel T₂ is a sensitivity channel having a time aperture interval that is ½ (=½¹) times the unit exposure time. In some example embodiments, the sensitivity channel T₂ has sensitivity for detection of photons over half of the unit exposure time. The sensitivity channel T₃ is a sensitivity channel having a time aperture interval that is ¼ (=½²) times the unit exposure time. In some example embodiments, the sensitivity channel T₃ has sensitivity for detection of photons over a quarter of the unit exposure time. Similarly, the time aperture intervals of the remaining sensitivity channels T₄ to T₇ may be determined.

A ratio of a time aperture interval of each of the sensitivity channels T₁ to T₇ to the unit exposure time (hereinafter referred to as a “time aperture ratio (TAR)”) is not limited to the ratios such as ½ and ¼. However, for convenience of hardware configuration, a TAR may be set to ½\hat{ }k (where k is 0 or a natural number).

The higher the illuminance of light incident on the APD 211 (hereinafter also referred to as “incident illuminance”), the larger the number of photons incident on the APD 211. In addition, because the SOE is common to all the sensitivity channels T₁ to T₇ and photons arrive at the APD 211 randomly, the probability that a photon is incident on the APD 211 during one charging period increases as the incident illuminance increases. In some example embodiments, the higher the incident illuminance, the higher the probability that a photon is incident on a sensitivity channel having low sensitivity and a short time aperture interval (hereinafter also referred to as the “low-sensitivity channel”).

Furthermore, because the time aperture intervals of the sensitivity channels Tᵢ (i=1, 2, . . . ) partially overlap with each other, when a photon is incident on a certain sensitivity channel Tᵢ, the photon is also incident on another sensitivity channel Tⱼ (j>i) having higher sensitivity than the sensitivity channel Ti. Accordingly, regardless of the time dependence of a timing at which a photon is incident on the APD 211, a time aperture interval of each of the sensitivity channels T₁ to T₇ may be made to correspond to a level (high or low) of sensitivity of each of the sensitivity channels T₁ to T₇, e.g., a weight related to the sensitivity. In some example embodiments, a time aperture interval may be treated as having the same meaning as the weight related to the sensitivity of a sensitivity channel.

In the time aperture imaging algorithm, the number of photons incident on the APD 211 is calculated based on the total sum of count values CNTᵢ of photons by the sensitivity channels Ti per unit exposure time. A method of calculating the number of photons is described below.

A count value CNT is initialized to 0 before counting starts. For each of the sensitivity channels T₁ to T₇, it is determined whether a photon is incident during a corresponding time aperture interval, and when a photon is incident on each of the sensitivity channels T₁ to T₇, 1 is added to the count value CNT. In some example embodiments, for each of the sensitivity channels T₁ to T₇, it is determined whether a photon is incident on each of the sensitivity channels T₁ to T₇ from the start of exposure until the end of exposure, and when a photon is incident thereon, 1 is added to the count value CNT. On the other hand, when a photon is not incident on each of the sensitivity channels T₁ to T₇, no value is added to the count value CNT. For example, when a photon is incident within the sensitivity channel T₇, 1 is added to the count value CNT for the sensitivity channel T₇. Because the SOE is common to all the sensitivity channels T₁ to T₇, 1 is also added to the count value CNT for each of the sensitivity channels T₁ to T₆. Therefore, a final count value CNT becomes 7. In some example embodiments, when a photon is incident during a period in which only the sensitivity channel T₁ is set, the final count value CNT becomes 1. When no photon is incident within the sensitivity channel T₁ at all, the final count value CNT becomes 0. In some example embodiments, counting of photons by the sensitivity channels Tᵢ may be implemented by, for example, the in-pixel counter 223, as described below.

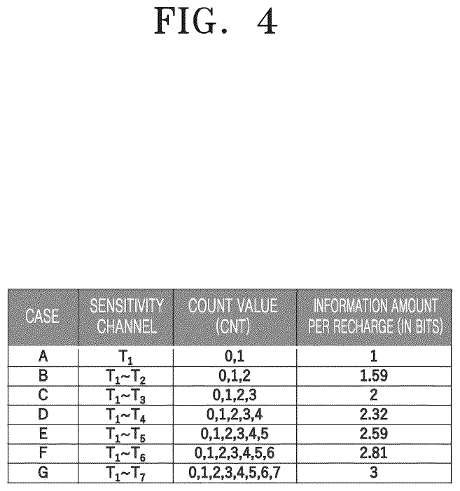

FIG. 4 is a diagram illustrating an information amount regarding the number of photons per recharge according to a sensitivity channel used, according to some example embodiments.

When an information amount I regarding the number of photons is defined as a base-2 logarithm, i.e., log₂ (CNT+1), the information I becomes a maximum of 3 bits per recharge when the sensitivity channels T₁ to T₇ are used. As the number of sensitivity channels Tᵢ used increases, more information related to the incident illuminance is obtained per recharge operation. In the definition formula for the information amount I, CNT represents a final count value.

In this way, information regarding the amount of incident light may be expressed and obtained at one time by using a plurality of bits (multi-bits) (hereinafter referred to as “multi-bit information acquisition”). In some example embodiments, the image sensor 100 may obtain a relatively larger amount of information regarding the amount of incident light for each illuminance level at one time by utilizing statistical properties of photons.

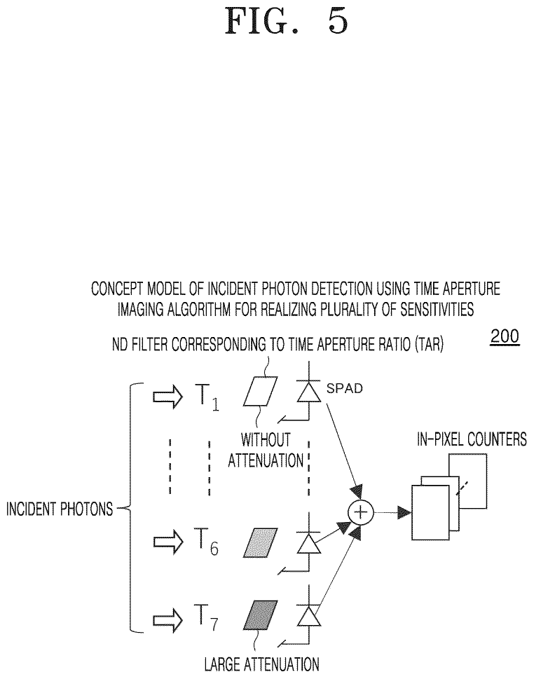

FIG. 5 is a schematic diagram illustrating a concept model of incident photon detection using a time aperture imaging algorithm for realizing a plurality of sensitivities. The multi-bit information acquisition may be modeled by a concept model shown in FIG. 5. In the concept model shown in FIG. 5, a plurality of SPAD elements are provided in one pixel, and neutral density (ND) filters corresponding to TARs are located in front of the SPAD elements. Each ND filter has different sensitivity characteristics depending on a TAR. The multi-bit information acquisition may be equivalent to an operation of counting all outputs (calculating the total sum of outputs) from the plurality of SPAD elements for incident light attenuated by the ND filters. In a complementary metal-oxide-semiconductor (CMOS) image sensor (CIS) according to a comparative example, it may be challenging to implement such modeling with a plurality of sensitivity characteristics due to a structure in which photoelectrically converted electrons are accumulated in a pixel at one time regardless of the amount of light.

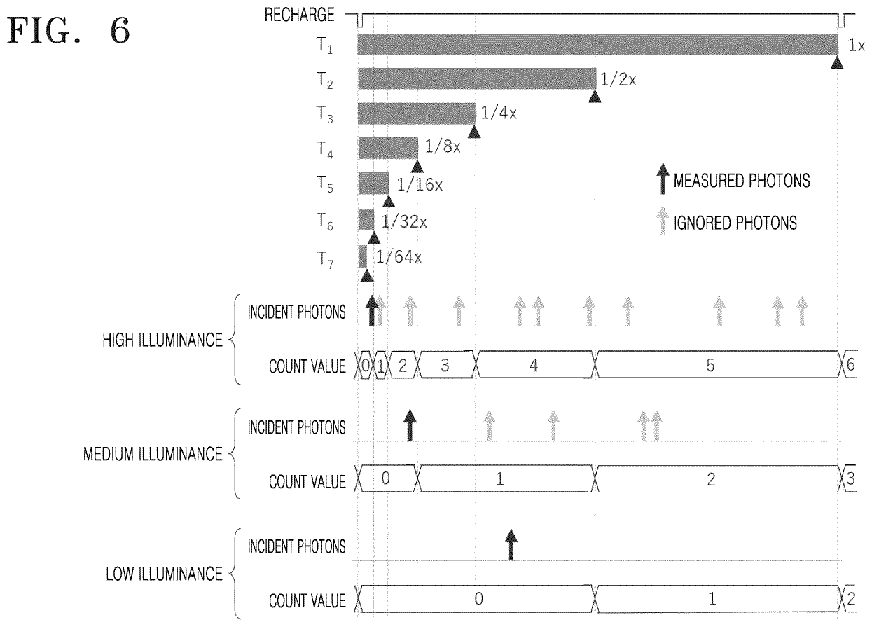

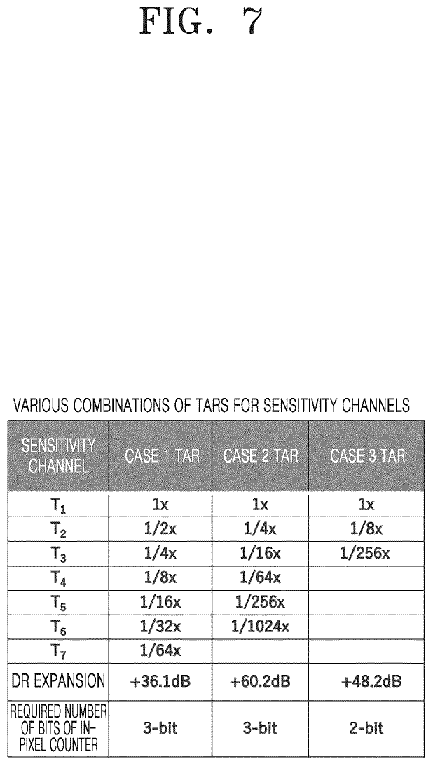

FIG. 6 is a diagram illustrating count values according to levels of illuminance, according to some example embodiments. FIG. 7 is a diagram illustrating dynamic range expansion ratios and the number of bits of an in-pixel counter, corresponding to various combinations of TARs for sensitivity channels, according to some example embodiments.

In the disclosure, an illuminance range over which the image sensor 100 is capable of detecting (counting) photons may be referred to as a dynamic range (or DR) for illuminance (hereinafter, also simply referred to as a “dynamic range”). Hereinafter, for convenience of description, a case where incident illuminance is divided into three levels, i.e., high illuminance, medium illuminance, and low illuminance, is described as an example. However, this is only an example, and the incident illuminance may be divided into more than three levels.

High-illuminance represents a relatively higher illuminance level such as that of sunlight. Under the high illuminance, the number of photons entering within a certain period of time is relatively larger. In addition, medium illuminance represents an extent of illuminance achievable by, for example, general indoor lighting. Low illuminance represents illuminance in a dark lighting environment, such as under moonlight at night. Under the low illuminance, a state in which even a single photon does not enter during one charging period may frequently occur.

As illustrated in FIG. 6, the number of photons incident during one charging period increases as the illuminance increases. Therefore, because the probability that a photon is incident even during a short time aperture interval set for a low-sensitivity channel increases, a final count value CNT may increase. For example, a ratio of the time aperture interval of the sensitivity channel T₇ having the lowest sensitivity to that of the sensitivity channel T₁ having the highest sensitivity is 64. In some example embodiments, in the sensitivity channel T₇, an increase in a count value is suppressed or reduced even for light having an illuminance 64 times higher than that for the sensitivity channel T₁. In some example embodiments, counting may be performed without saturating the count value with a small number of bits of the in-pixel counter. In some example embodiments, an illuminance range in which each sensitivity channel operates linearly may be controlled by a TAR, and as a result, a dynamic range in the pixel 200 may be increased.

For each of the high illuminance, medium illuminance, and low illuminance, the APD 211 measures (or otherwise detects) a first incident photon during a charging period. Moreover, because a potential difference between the anode 2112 and the cathode 2111 of the APD 211 decreases due to the measurement of the first photon, the APD 211 does not measure photons incident second and subsequently. In some example embodiments, the second and subsequent incident photons are ignored. In the example of the high illuminance illustrated in FIG. 6, a first incident photon is measured during the time aperture interval of the sensitivity channel T₆ after the time aperture interval of the sensitivity channel T₇, and photons incident second and subsequently are ignored. However, according to the time aperture imaging algorithm of the present embodiment, counting is performed from the sensitivity channel T₆ to the sensitivity channel T₁, resulting in a counter value of 6. Furthermore, in the example of the medium illuminance, a first incident photon is measured during the time aperture interval of the sensitivity channel T₄ after the time aperture interval of the sensitivity channel T₅, and photons incident second and subsequently are ignored. However, counting is performed from the sensitivity channel T₄ to the sensitivity channel T₁, resulting in a count value of 4. Furthermore, in the example of the low illuminance, a first incident photon is measured during the time aperture interval of the sensitivity channel T₂ after the time aperture interval of the sensitivity channel T₃, and photons incident second and subsequently are ignored. However, counting is performed in the sensitivity channels T₂ and T₁, resulting in a count value of 2.

According to some example embodiments, the number of sensitivity channels to be set may be one or a plurality. In order to obtain an effect of expanding the dynamic range, a plurality of sensitivity channels Tᵢ may be set. However, the time aperture interval of each sensitivity channel Ti needs to be set to include the time aperture interval of a sensitivity channel having lower sensitivity. Due to such constraints on the setting of the sensitivity channels, time dependence is canceled even for photons arriving randomly, thereby realizing an input-output transfer function, as described below, in which a sensitivity ratio of each sensitivity channel Ti is preserved.

As illustrated in FIG. 7, a dynamic range may be arbitrarily expanded by setting, for each sensitivity channel Tᵢ, a TAR relative to that of the sensitivity channel T₁, and a dynamic range expansion ratio DR_{EXT} may be defined by using Equation 1 below.

$${DR}_{EXT} = 20 log ( \frac{1}{TAR} ) [ dB ] \qquad [ Equation 1 ]$$

In Equation 1, TAR denotes a time aperture ratio.

FIG. 7 illustrates dynamic range (or DR) expansion calculated for Cases 1, 2, and 3, according to some example embodiments. In addition, the number of bits of an in-pixel counter required to implement photon counting in hardware for each case is also illustrated. In this way, a characteristic of easily controlling dynamic range expansion, is referred to as “ease of DR expansion control.”

Furthermore, by adjusting the number of sensitivity channels and a TAR, it is possible to suppress or reduce the occurrence of signal-to-noise ratio (SNR) dips or the like or to perform a trade-off design between the SNR and a DR expansion ratio (referred to as “ease of trade-off design”). In addition, by preparing a mode according to an imaging scene in consideration of the trade-off design, optimization including power consumption of the entire imaging system or signal processing within the imaging system may be performed.

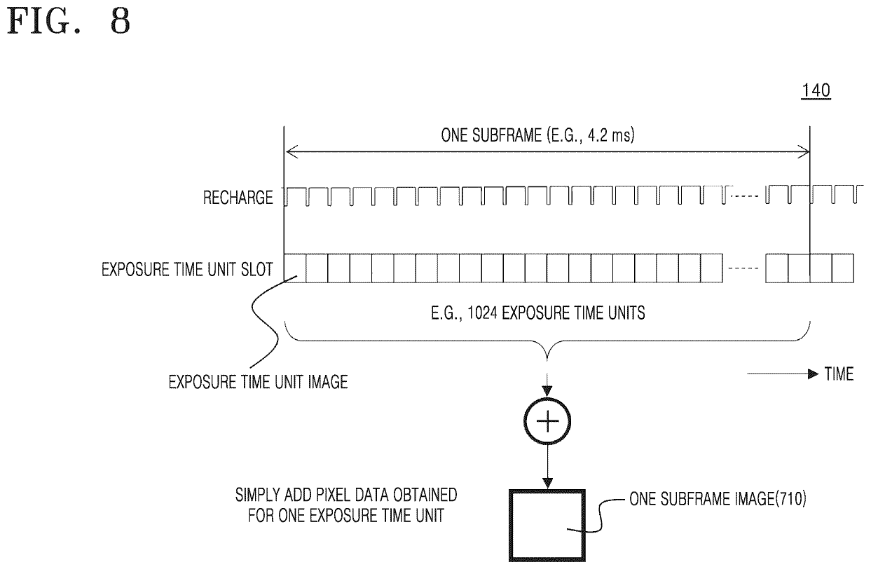

FIG. 8 is a schematic diagram illustrating a data accumulator that reconstructs an image based on pixel data, according to some example embodiments. The data accumulator 130 may reconstruct an image as a subframe image 710, for example, by adding pixel data.

In SPAD-based imaging, unlike CIS imaging, readout noise and quantization noise are reduced or minimal due to a relatively higher photoelectric conversion gain. In some example embodiments, in the SPAD-based imaging, the readout noise and the quantization noise are zero or negligible or substantially reduced, and furthermore, images may be obtained during accumulation for imaging. Therefore, in the SPAD-based imaging, even when images obtained during accumulation are accumulated to generate an image, there is reduced degradation in SNR due to noise, and image quality rather improves as the number of accumulations increases because a ratio of shot noise to a signal decreases. In this way, the SPAD-based imaging may have improved characteristics in terms of SNR and image quality.

As illustrated in FIG. 8, for example, the data accumulator 130 may generate the subframe image 710 by adding, for each pixel 200, pixel data obtained for each exposure time unit. In some example embodiments, the data accumulator 130 may obtain a 3-bit frame image in one exposure time unit, and generate one subframe image 710 by simply adding the obtained frame images.

FIG. 9 is a circuit diagram of hardware of the pixel 200 that is configured with a two-layer substrate. For example, the pixel 200 may include the light-receiving unit 210 including the APD 211 mounted on a first layer (e.g., a first substrate), and the pixel circuit 220 mounted on a second layer (e.g., a second substrate). An output of the APD 211 on the first layer is propagated to the pixel circuit 220 on the second layer by a hybrid bonding stacking technology.

The pixel circuit 220 on the second layer may include the charging circuit 221, the gating circuit 222, the in-pixel counter 223, the readout latch circuit 224, the SEL 225, and the output bus 228.

The charging circuit 221 recharges the cathode 2111 of the APD 211 once per unit exposure time based on a charging signal.

The gating circuit 222 may control a count-up operation of the in-pixel counter 223 by controlling a clock input of the in-pixel counter 223. In some example embodiments, the gating circuit 222 includes a NOR element, and the NOR element may receive a cathode node potential Vc and a CHK signal as inputs and output an OUT signal.

The in-pixel counter 223 may include a ripple counter having a 3-bit counter, and is initialized to 0 by a reset bar (RSTB) signal. The in-pixel counter 223 may detect an output (e.g., photon) of the APD 211 by counting up (incrementing) a value on a rising edge of the OUT signal. The in-pixel counter 223 may have an arbitrary number of bits as long as the in-pixel counter 223 is able to count values greater than or equal to the number of sensitivity channels Tᵢ. According to some example embodiments, because the size of the pixel 200 is rate-limited by the size of the in-pixel counter 223, a relatively smaller size of the in-pixel counter 223 may be desirable. In FIG. 9, a configuration with 3 bits is illustrated as an example.

The readout latch circuit 224 holds each bit output of the in-pixel counter 223 in response to a charging signal. The SEL 225 controls readout of bit values, which are held in the readout latch circuit 224, via the output bus 228 in response to a SEL signal. In addition, the width (number of bits) of the output bus 228 may match the number of bits of the in-pixel counter 223, but they may not match each other. According to some example embodiments, a smaller output bus width may be advantageous for miniaturizing the entire pixel 200 because the smaller output bus width may reduce a layout area required for wiring. According to some example embodiments, only the most significant bit of the in-pixel counter 223 may be held in the readout latch circuit 224.

The readout latch circuit 224 is provided in order to perform readout of a count value of the in-pixel counter 223 while temporally overlapping with time aperture imaging. The readout of all the pixels 200 is completed in one charging period. In some example embodiments, because a unit exposure time may overlap a readout time, a dead (insensitive) period of imaging due to readout does not occur, thereby enabling imaging with reduced sensitivity loss. Alternatively, instead of including the readout latch circuit 224, readout may be performed at a relatively lower speed over one or more charging periods by implementing one or more extra bits in the in-pixel counter 223.

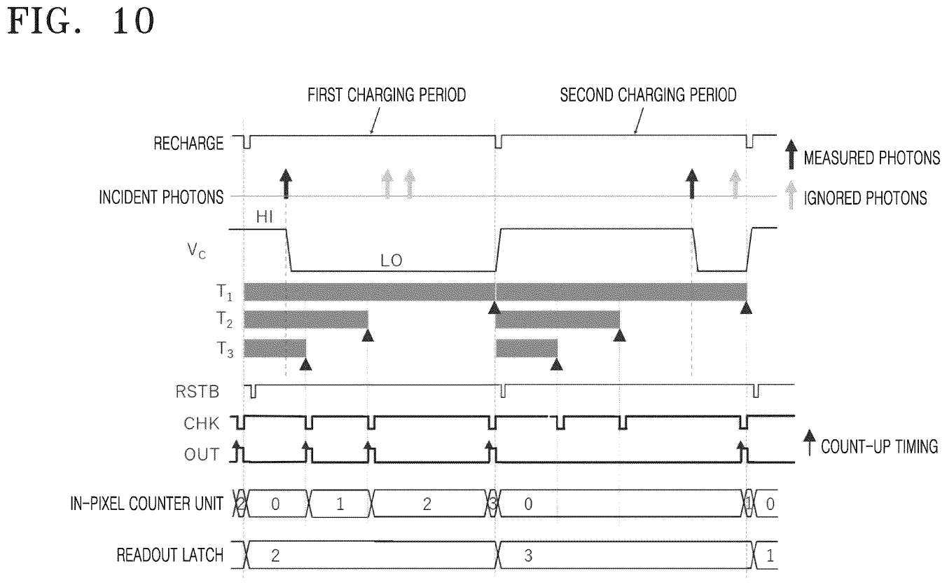

FIG. 10 is a timing chart illustrating an operation of the pixel circuit 220 shown in FIG. 9. However, to simplify the description of the counter operation, values different from those in an actual circuit operation are used. For example, it may be described that the value of the in-pixel counter 223 decreases when a clock is applied, but no inconsistency occurs in the operation itself even when the value is treated as increasing.

When the charging signal becomes a low level LO, the cathode node potential Vc of the APD 211 is pulled up to a high level HI. As a result, the APD 211 operates in a Geiger mode, thereby being ready to receive photons.

When a photon is incident on the APD 211, avalanche breakdown occurs, causing the cathode node potential Vc to drop to a low level.

When an RSTB signal of the in-pixel counter 223 becomes a low level, the in-pixel counter 223 is cleared to 0. Thus, a counting operation is prepared or initiated.

When a CHK signal becomes a low level, a logic state of the cathode node potential Vc is propagated to and confirmed as an OUT signal. When the cathode node potential Vc is at a high level, the OUT signal becomes a low level according to NOR logic. When the cathode node potential Vc is at a low level, the OUT signal becomes a high level according to the NOR logic. Because a rising edge may be generated when the OUT signal becomes a high level, a count value of the in-pixel counter 223 is incremented accordingly.

In this way, the gating circuit 222 propagates the logic state of the cathode node potential Vc to the OUT signal according to the logic state of the CHK signal. As a result, the state of the cathode node potential Vc of the APD 211 (the output of the APD 211) is confirmed at a timing selected from among a plurality of different end timings of the sensitivity channels Ti.

When an avalanche breakdown occurs, the cathode node potential Vc maintains its state, and a count value is incremented each time the CHK signal becomes a low level. Accordingly, time aperture imaging may be performed. In the example of FIG. 10, three sensitivity channels T₁, T₂, and T₃ are set, and a first photon is incident in the sensitivity channel T₃ during a first charging period. Therefore, counting is performed three times by CHK signals respectively corresponding to the sensitivity channel T₃, the sensitivity channel T₂, and the sensitivity channel T₁. In a second charging period, a first photon is incident in the sensitivity channel T₁. Therefore, counting is performed once by the CHK signal of the sensitivity channel T₁.

When the charging signal becomes a low level, an output value of the in-pixel counter 223 is written to the readout latch circuit 224 (LO-through-HI-Latch). In some example embodiments, when the charging signal is at a low level, the readout latch circuit 224 passes through (does not hold) the output value of the in-pixel counter 223, and when the charging signal is at a high level, it latches (holds) the output value. The value written to the readout latch circuit 224 is read out over one charging period. In the example of FIG. 10, at a timing when the charging signal in the second charging period transitions from a low level to a high level, the count value “3” from the first charging period is written to the readout latch circuit 224 and is read out during the second charging period. In addition, subsequent incident photons within one charging period are ignored and not counted.

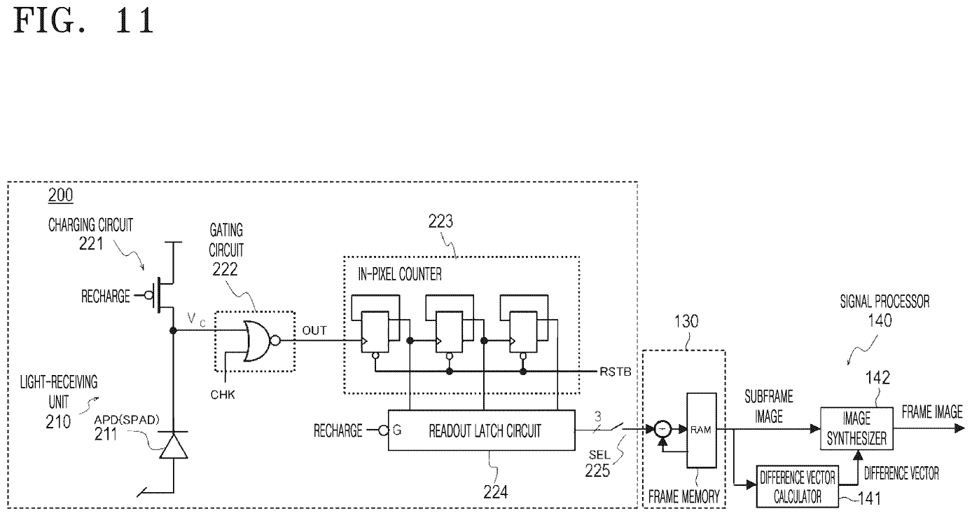

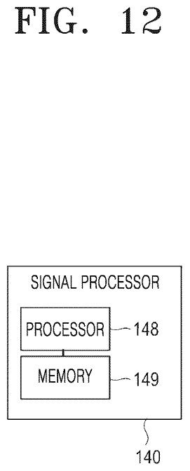

FIG. 11 is a schematic block diagram illustrating a configuration of the signal processor 140 shown in FIG. 1. FIG. 12 is a block diagram illustrating a hardware configuration of the signal processor 140, according to some example embodiments. In FIG. 11, for convenience of description, the pixel 200 and the data accumulator 130 are also illustrated. The signal processor 140 includes a difference vector calculator 141 and an image synthesizer 142. As illustrated in FIG. 12, the signal processor 140 may be configured by a processor 148 and a memory 149 communicably coupled to the processor 148. According to some example embodiments, the processor 148 may include a central processing unit (CPU) and random access memory (RAM), and the memory 149 may include a hard disk drive (HDD) or a solid state drive (SSD), but is not limited thereto.

The difference vector calculator 141 may calculate a difference vector (750 of FIG. 13) based on a subframe image 710. The difference vector 750 is a vector of which elements are a length and a direction of a line connecting each pixel 200 of a subframe image 710 that is temporally preceding to a corresponding pixel of a subframe image 710 that is temporally succeeding. In some example embodiments, the difference vector 750 is a vector having, as an end point, a pixel 200 of a reference subframe described below, and, as a starting point, a pixel 200 of a non-reference subframe image that corresponds to the pixel 200 of the end point. Because a method of calculating the difference vector 750 is well known, a description thereof is omitted. For example, an optical flow algorithm may be used to calculate the difference vector 750.

The difference vector calculator 141 may calculate the difference vector 750 for each subframe image 710. In some example embodiments, the difference vector calculator 141 may set one of a plurality of subframe images 710 generated in a time series as a reference subframe, and calculate, for at least one non-reference subframe image other than the reference subframe image, the difference vector 750 for each pixel 200 with respect to the reference subframe. In some example embodiments, the difference vector 750 may be calculated for each non-reference subframe image. The non-reference subframe images may be all subframe images 710 included in one frame, other than the reference subframe image. The non-reference subframe images may also be a predetermined or desired number of subframe images 710 before and after the reference subframe image. As described below, the non-reference subframe images are corrected based on the respective difference vectors 750 and then added to the reference subframe image, thereby generating the frame image (700 of FIG. 13). Each subframe image 710 is sequentially processed as a reference subframe image.

The image synthesizer 142 may generate the frame image 700 by correcting the non-reference subframe images based on the respective difference vectors 750 and adding the corrected non-reference subframe images to the reference subframe image.

FIG. 13 illustrates an operation of the signal processor 140, according to some example embodiments. In the example shown in FIG. 13, a camera having the image sensor 100 is fixed or stationary.

Subframe images 710a, 710b, 710c, 710d, and 710e are generated in a time series on a subframe-by-subframe basis. In the example illustrated in FIG. 13, the subframe image 710c is considered as a reference subframe image, and the subframe images 710a, 710b, 710d, and 710e may correspond to non-reference subframe images. The subframe images 710 are generated (captured) in the order of 710a, 710b, 710c, 710d, and 710e.

A difference vector 750 for each pixel 200 with respect to the reference subframe image may be calculated for each non-reference subframe image. In FIG. 13, the difference vectors 750 are illustrated by arrows in the subframe images 710a, 710b, 710d, and 710e, which are the non-reference subframe images. The difference vector 750 is a vector having, as an end point, a pixel 200 of the reference subframe, and, as a starting point, a pixel 200 of a non-reference subframe image that corresponds to the pixel 200 of the end point. In some example embodiments, the difference vector 750 is a vector having, as an end point, coordinates on the non-reference subframe image corresponding to coordinates of an arbitrary pixel 200 of the reference subframe image, and as a starting point, coordinates of a pixel 200 on the non-reference subframe image corresponding to the arbitrary pixel 200 of the reference subframe image. The difference vector 750 may be a difference vector for a non-reference subframe image that is to be corrected with respect to the reference subframe image. In some example embodiments, the difference vector 750 is a vector representing a direction and the amount of movement for each pixel 200 of the non-reference subframe in order to perform correction to align a capture time of the non-reference subframe with that of the reference subframe image.

For each non-reference subframe image, correction is performed to shift each pixel 200 of the non-reference subframe image in the same direction as the direction of the difference vector 750 by a length of the difference vector 750. Thereafter, the frame image 700 may be generated by adding the corrected non-reference subframe images to the reference subframe image. The same synthesis process may be sequentially performed for the next frame image 700 as well.

Through the above process, an effect of suppressing or reducing or limiting motion blur may be improved with relative ease regardless of the speed of a moving object being captured, while obtaining an image signal corresponding to an exposure time of one frame.

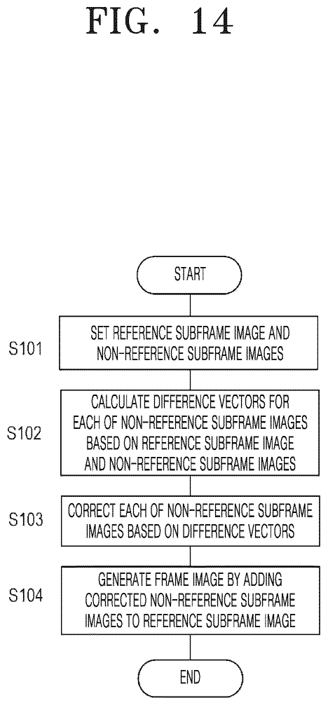

FIG. 14 is a flowchart illustrating operations of the signal processor 140. The flowchart may be executed by the processor 148 of the signal processor 140 according to computer readable program instructions stored in the memory 149. It is understood that additional operations can be provided before, during, and after the operations in FIG. 14, and some of the operations described below can be replaced or eliminated, for additional embodiments of the method. The order of the operations/processes may be interchangeable, or two or more operations can be performed simultaneously.

In operation S101, the processor 148 sets, from among the subframe images 710, a reference subframe image and non-reference subframe images.

In operation S102, the processor 148 calculates a difference vector for each of the non-reference subframe images based on the reference subframe image and the non-reference subframe images.

In operation S103, the signal processor 140 corrects each of the non-reference subframe images based on the difference vector.

In operation S104, the processor 148 generates the frame image 700 by adding the corrected non-reference subframe images to the reference subframe image.

Hereinafter, a second example embodiment is described. The difference between the second example embodiment and the first example embodiment is as follows. In the first example embodiment, a subframe rate, which is a frame rate of the subframe images 710, is constant. In the second embodiment, a subframe rate is changed depending on the magnitude of the difference vector 750. In other respects, the second embodiment is the same as or similar in some respects to the first example embodiment, and thus repeated descriptions are omitted or simplified.

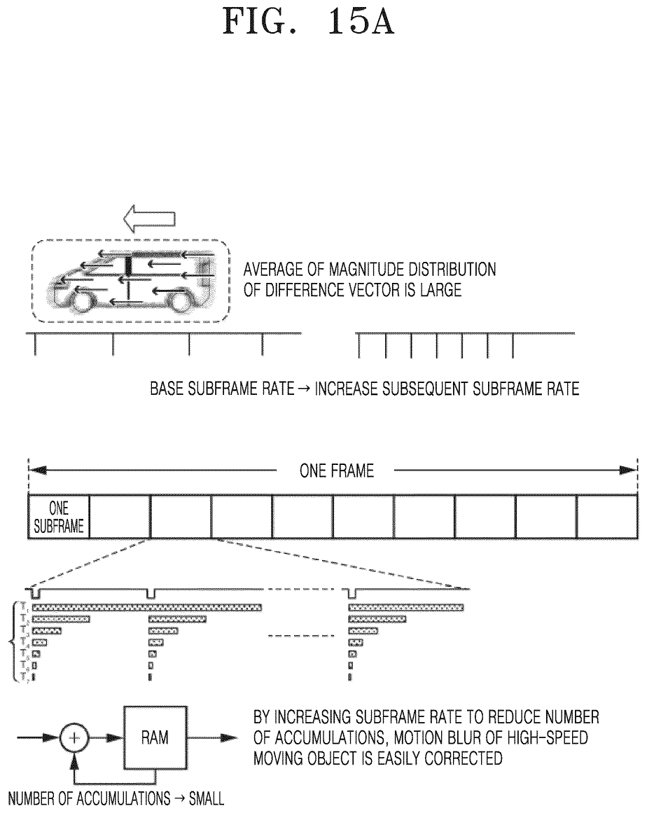

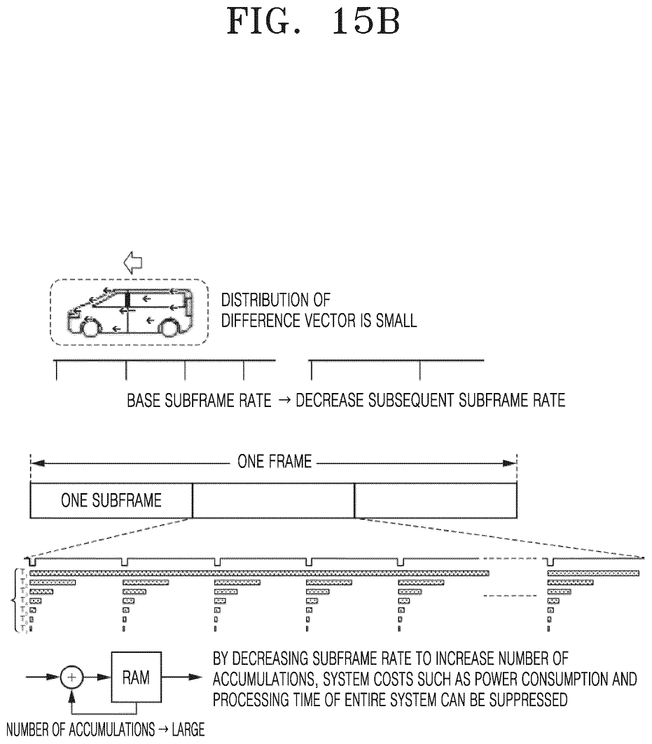

FIG. 15A illustrates a process of increasing a subframe rate when the magnitude of the difference vector 750 is large. FIG. 15B illustrates a process of decreasing a subframe rate when the magnitude of the difference vector 750 is small. According to some example embodiments, the difference vector 750 used for changing the subframe rate may be a difference between any two subframes within one frame (a reference subframe image and a non-reference subframe image), and for example, the difference vector 750 is calculated for each pixel by setting a first subframe within one frame as the reference subframe image and a last subframe as the non-reference subframe image. The same applies to example embodiments described below.

The processor 148 of the signal processor 140 may increase the subframe rate when the magnitude of the difference vector 750 is greater than a predetermined or desired first threshold value, and decrease the subframe rate when the magnitude of the difference vector 750 is less than a predetermined or desired second threshold value. According to some example embodiments, the first threshold value may be greater than the second threshold value. According to some example embodiments, the first threshold value may be equal to the second threshold value. The first threshold value and the second threshold value may be set to appropriate values through experiments from the viewpoint of suppressing or reducing motion blur or the like.

In FIG. 15A, an example is shown in which a subsequent subframe rate is increased when an average of a magnitude distribution of the difference vectors 750 of one subframe image 710 is greater than the first threshold value. In some example embodiments, when the average of the magnitude distribution of the difference vectors 750 of one subframe image 710 is greater than the first threshold value, the subsequent subframe rate may be increased to a subframe rate higher than a base subframe rate, which is a default subframe rate. In an image of a relatively fast-moving object where the magnitude of the difference vector 750 increases, the likelihood of motion blur increases. By increasing the subframe rate to increase the number of subframe images 710 included in one frame, the number of accumulations by the data accumulator 130 may be reduced, thereby facilitating correction of motion blur of a high-speed moving object.

In FIG. 15B, an example is shown in which a subsequent subframe rate is decreased when an average of a magnitude distribution of the difference vectors 750 of one subframe image 710 is less than the second threshold value. In some example embodiments, when the average of the magnitude distribution of the difference vectors 750 of one subframe image 710 is less than the second threshold value, the subsequent subframe rate may be decreased to a subframe rate lower than the base subframe rate. For an image in which the likelihood of motion blur is relatively low because no high-speed moving object is included, by decreasing the subframe rate, the number of accumulations per subframe may be increased and the number of subframe images 710 included in one frame may be reduced, thereby suppressing or reducing system costs such as power consumption and processing time of the entire system.

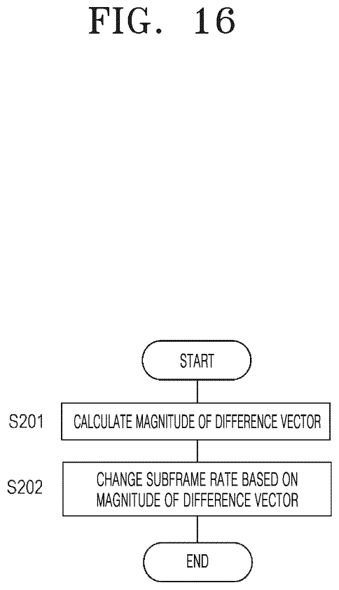

FIG. 16 is a flowchart illustrating operations of the signal processor 140, according to some example embodiments. The flowchart may be executed according to computer readable program instructions stored in the memory 149 and through cooperation between the controller 110 and the processor 148 of the signal processor 140. It is understood that additional operations can be provided before, during, and after the operations in FIG. 16, and some of the operations described below can be replaced or eliminated, for additional embodiments of the method. The order of the operations/processes may be interchangeable, or two or more operations can be performed simultaneously.

In operation S201, the processor 148 calculates a magnitude of the difference vector 750.

In operation S202, the processor 148 changes a subframe rate based on the magnitude of the difference vector 750. The processor 148 may change the subframe rate based on an average of a magnitude distribution of the difference vectors 750 of one subframe image 710. The processor 148 may also change the subframe rate based on a median value of a magnitude distribution of the difference vectors 750 of one subframe image 710. According to some example embodiments, the processor 148 may change the subframe rate based on an average value or a median value of a magnitude distribution of some difference vectors 750 of a non-reference subframe image that is closest to a reference subframe image in a time series. In some example embodiments, the processor 148 may change the subframe rate based on an average value or a median value of a magnitude distribution of the difference vectors 750 of one of two subframe images adjacent to the reference subframe image, preceding and following the reference subframe image in a time series.

Hereinafter, a third example embodiment is described. The difference between the second example embodiment and the third example embodiment is as follows. In the first example embodiment, the difference vector 750 is calculated for the subframe image 710, and the subframe image 710 is corrected based on the calculated difference vector 750. On the other hand, in the third example embodiment, the difference vector 750 is calculated for a region of interest (ROI) 151 set for the subframe image 710, and the subframe image 710 is corrected based on the calculated difference vector 750. In other respects, the third example embodiment is the same as or similar in some respects to the first example embodiment, and thus repeated descriptions are omitted or simplified. In addition, the third example embodiment may be configured for performing capturing by fixing a camera having the image sensor 100.

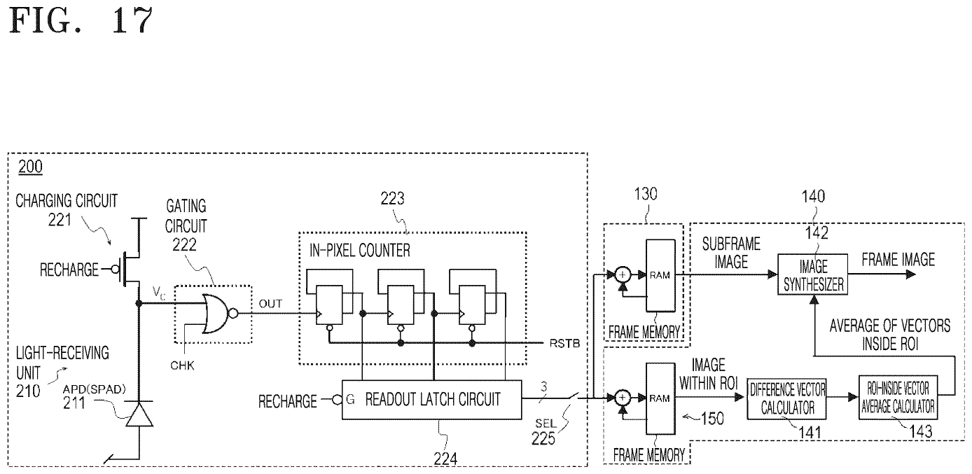

FIG. 17 is a schematic block diagram of a configuration of the signal processor 140. In FIG. 17, for the sake of description, the pixel 200 and the data accumulator 130 are also illustrated. The signal processor 140 includes a region of interest (ROI) data accumulator 150, a difference vector calculator 141, a vector average calculator 143 for calculating an average of vectors inside an ROI (hereinafter referred to as an ROI inside vector average calculator 143), and an image synthesizer 142. In some example embodiments, the ROI data accumulator 150 may also be included in the data accumulator 130.

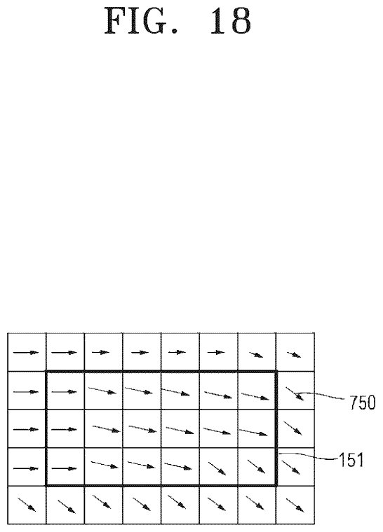

The ROI data accumulator 150 generates an image within an ROI 151 (FIG. 18) by accumulating, over a plurality of unit exposure times, count values per unit exposure time for the ROI 151, which is preset as a coordinate region in image data among image regions of the image data. Because the ROI 151 is a coordinate region, the ROI 151 is also a coordinate region of the subframe image 710 and a coordinate region of the frame image 700. Hereinafter, for the sake of description, a case where the ROI 151 is set for a non-reference subframe image is described as an example.

The image within the ROI 151 corresponds to image data obtained by extracting data within the ROI 151 from the subframe image 710.

FIG. 18 is an explanatory diagram illustrating the ROI 151, according to some example embodiments. A square grid shown in FIG. 18 represents image data of each pixel 200 of a non-reference subframe image, which is a subframe image 710.

As in the example shown in FIG. 18, one ROI 151 may be set at the center of the non-reference subframe image. A plurality of ROIs 151 may also be set at the center and regions other than the center of the non-reference subframe image.

The difference vector calculator 141 may calculate difference vectors 750 based on an image within the ROI 151. The difference vectors 750 may be calculated based on an image within an ROI of a reference subframe image and an image within an ROI of each non-reference subframe image, by using the same method as that used to calculate the difference vectors 750 from the subframe images 710 in the first embodiment. The difference vector calculator 141 calculates the difference vectors 750 for each image within the ROI 151 of a non-reference subframe image.

The ROI inside vector average calculator 143 calculates an average of the difference vectors 750 for each image within the ROI 151 of a non-reference subframe image.

The image synthesizer 142 generates a frame image 700 by correcting each non-reference subframe image based on the average of the difference vectors 750, and adding the corrected non-reference subframe images to the reference subframe image.

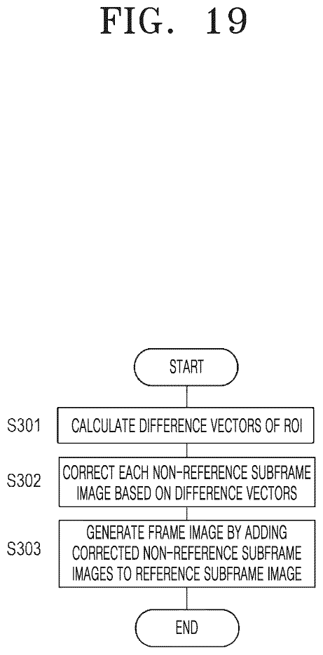

FIG. 19 is a flowchart illustrating operations of the signal processor 140, according to some example embodiments. The flowchart may be executed by the processor 148 of the signal processor 140 according to computer readable program instructions stored in the memory 149. It is understood that additional operations can be provided before, during, and after the operations in FIG. 19, and some of the operations described below can be replaced or eliminated, for additional embodiments of the method. The order of the operations/processes may be interchangeable, or two or more operations can be performed simultaneously.

In operation S301, the processor 148 calculates the difference vectors 750 of the ROI 151.

In operation S302, the processor 148 corrects each non-reference subframe image based on the difference vectors 750. For example, the processor 148 corrects each non-reference subframe image based on an average magnitude of the difference vectors 750. The processor 148 may also correct each non-reference subframe image based on a median magnitude of the difference vectors 750.

In operation S303, the processor 148 generates a frame image by adding the corrected non-reference subframe images to the reference subframe image.

Because only the difference vectors 750 inside the ROI 151 are calculated, and the frame image 700 is generated by correcting the non-reference subframe images based on an average of the difference vectors 750 and adding the corrected ones to the reference subframe image, processing costs for calculating the difference vectors 750 may be reduced.

Hereinafter, a fourth example embodiment is described. Differences between the fourth example embodiment and the second and third example embodiments are as follows. In the second example embodiment, the subframe rate is changed according to whether an average of magnitudes of difference vectors calculated for one non-reference frame image is large or small. On the other hand, in the fourth example embodiment, the subframe rate is changed according to magnitudes of the difference vectors 750 corresponding to the pixels 200 inside the ROI 151 set in the subframe image 710. In the third example embodiment, a non-reference subframe is corrected based on the average of the difference vectors 750 calculated by the ROI inside vector average calculator 143, and is added to the reference subframe. On the other hand, in the fourth example embodiment, the subframe rate is changed according to a magnitude of the average of the difference vectors 750 calculated by the ROI inside vector average calculator 143. In other respects, the fourth example embodiment is the same as or similar in some respects to the second example embodiment or the third embodiment, and thus repeated descriptions are omitted or simplified.

The processor 148 of the signal processor 140 controls the subframe rate based on the difference vectors 750 corresponding to the pixels 200 within one or more ROIs 151 of the subframe image 710. In some example embodiments, the processor 148 increases the subframe rate when the average magnitude of the difference vectors 750 is greater than a first threshold value, and decreases the subframe rate when the average magnitude of the difference vectors 750 is less than a second threshold value. The first threshold value may be greater than or equal to the second threshold value. The average of the difference vectors 750 may be calculated by using the same or similar method as in the third example embodiment.

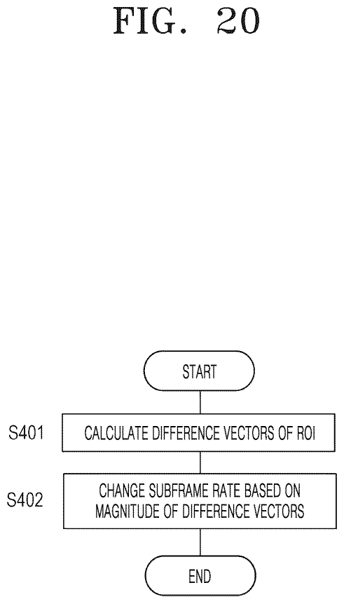

FIG. 20 is a flowchart illustrating operations of the signal processor 140, according to some example embodiments. The flowchart may be executed by the processor 148 of the signal processor 140 according to computer readable program instructions stored in the memory 149.

In operation S401, the processor 148 calculates the difference vectors 750 of the ROI 151.

In operation S402, the processor 148 changes a subframe rate based on a magnitude of the difference vectors 750. For example, the processor 148 may change the subframe rate based on an average magnitude of the difference vectors 750. For example, the processor 148 may change the subframe rate based on a median of magnitudes of the difference vectors 750.

Hereinafter, a fifth example embodiment is described. The difference between the fifth example embodiment and the second example embodiment is as follows. In the second example embodiment, the subframe rate is changed according to whether an average of magnitudes of the difference vectors 750 calculated for one non-reference frame image is large or small. On the other hand, in the fifth example embodiment, the subframe rate is changed based on at least one of the number and density of difference vectors 750 having periodicity. In other respects, the fifth example embodiment is the same as or similar in some respects to the second embodiment, and thus repeated descriptions are omitted or simplified.

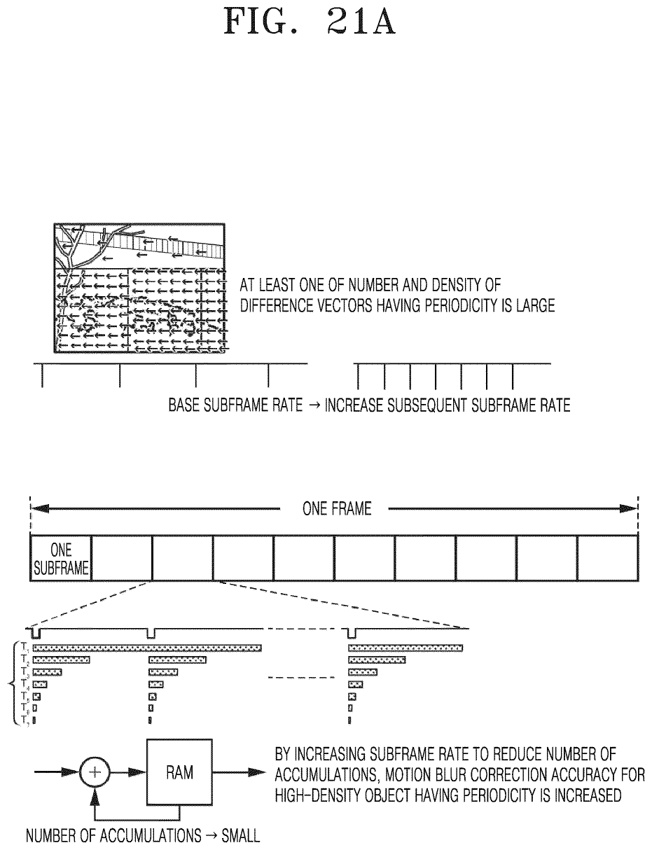

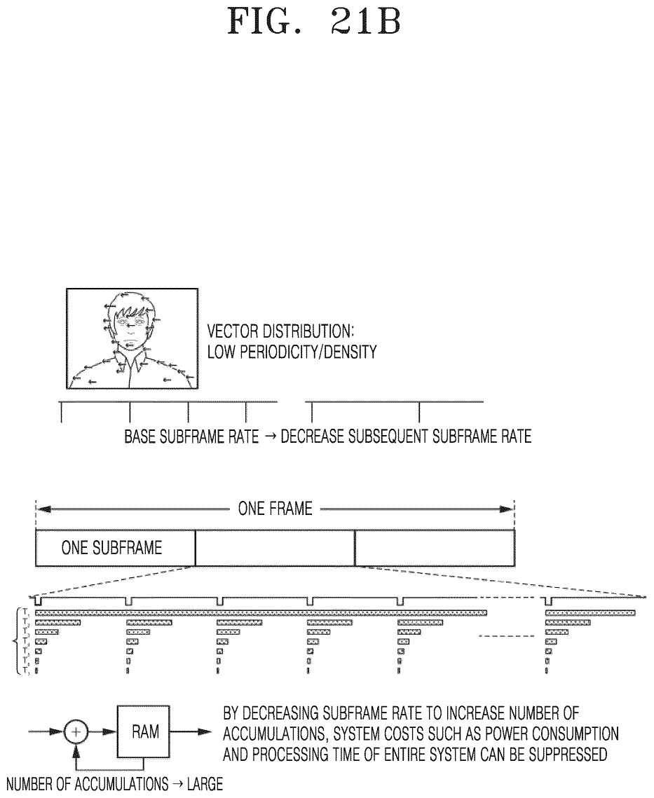

FIG. 21A illustrates a process of increasing the subframe rate relative to a base subframe rate when at least one of the number and density of the difference vectors 750 having periodicity is large, according to some example embodiments. FIG. 21B illustrates a process of decreasing the subframe rate relative to a base subframe rate when at least one of the number and density of the difference vectors 750 having periodicity is small, according to some example embodiments.

The processor 148 of the signal processor 140 increases the subframe rate when at least one of the number and density of the difference vectors 750 having periodicity is greater than a predetermined or desired third threshold value, and decreases the subframe rate when at least one of the number and density of the difference vectors 750 having periodicity is less than a predetermined or desired fourth threshold value. According to some example embodiments, it may be determined that there is periodicity when a number of difference vectors 750 have directions and magnitudes within a predetermined or desired threshold range. According to some example embodiments, the third threshold value may be greater than the fourth threshold value, or may be equal to the fourth threshold value. The third threshold value and the fourth threshold value may be set to appropriate values through experiments from the viewpoint of suppressing or reducing motion blur or the like.

FIG. 21A illustrates an example in which a subsequent subframe rate is increased when at least one of the number and density of the difference vectors 750 having periodicity in a distribution of the difference vectors 750 is greater than the third threshold value. When at least one of the number and density of the difference vectors 750 having periodicity is relatively large, the likelihood of motion blur increases. By increasing the subframe rate to increase the number of subframe images 710 included in one frame and reducing the number of accumulations performed by the data accumulator 130, motion blur correction accuracy for a high-density object having periodicity may be improved.

FIG. 21B illustrates an example in which a subsequent subframe rate is decreased when at least one of the number and density of the difference vectors 750 having periodicity in the distribution of the difference vectors 750 is less than the fourth threshold value. For an image in which at least one of the number and density of the difference vectors 750 having periodicity is relatively small and the likelihood of motion blur is relatively low, by decreasing the subframe rate, the number of accumulations per subframe may be increased and the number of subframe images 710 included in one frame may be reduced, thereby suppressing or reducing system costs such as power consumption and processing time of the entire system.

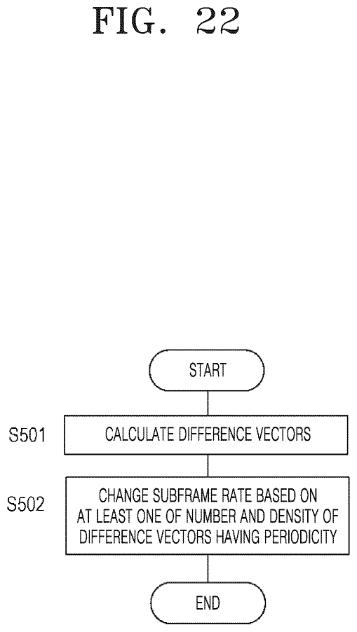

FIG. 22 is a flowchart illustrating operations of the signal processor 140. The flowchart may be executed by the processor 148 of the signal processor 140 according to computer readable program instructions stored in the memory 149. It is understood that additional operations can be provided before, during, and after the operations in FIG. 22, and some of the operations described below can be replaced or eliminated, for additional embodiments of the method. The order of the operations/processes may be interchangeable, or two or more operations can be performed simultaneously.

In operation S501, the processor 148 calculates magnitudes of the difference vectors 750.

In operation S502, the processor 148 changes a subframe rate based on at least one of the number and density of the difference vectors 750 having periodicity.

Hereinafter, a sixth example embodiment is described. Differences between the sixth example embodiment and the second example embodiment are as follows. In the second example embodiment, the subframe rate is changed according to whether an average of magnitudes of the difference vectors 750 calculated for one non-reference frame image is large or small. On the other hand, in the sixth example embodiment, based on the difference vectors 750 corresponding to pixels 200 inside and outside at least one ROI 151 set based on the subframe image 710, a subframe rate for the pixels 200 inside the ROI 151 and a subframe rate for the pixels 200 outside the ROI 151 may be changed separately. In some example embodiments, the subframe rate for the pixels 200 inside the ROI 151 may be increased, and the subframe rate for the pixels 200 outside the ROI 151 may be decreased. In other respects, the sixth example embodiment is the same as or similar in some respects to the second embodiment, and thus repeated descriptions are omitted or simplified.

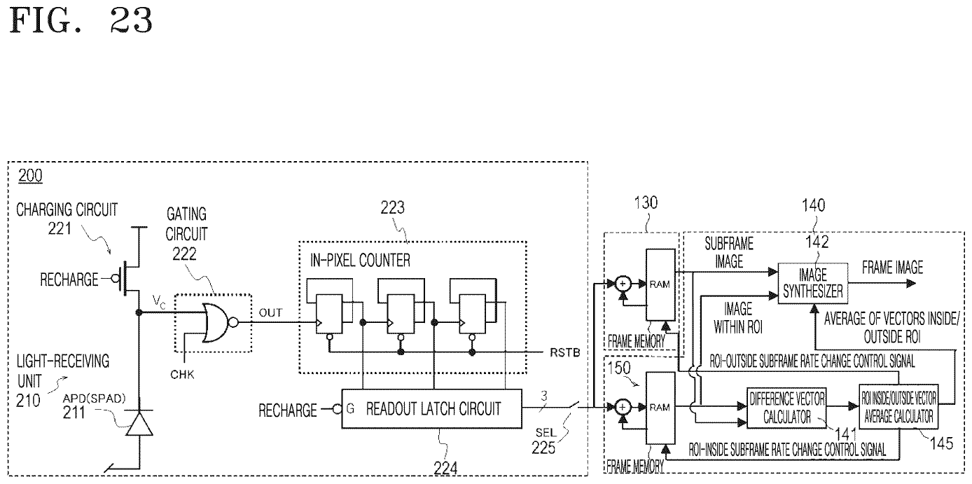

FIG. 23 is a schematic block diagram illustrating a configuration of the signal processor 140, according to some example embodiments. In FIG. 23, for the sake of description, the pixel 200 and the data accumulator 130 are also illustrated. The signal processor 140 includes an ROI data accumulator 150, a difference vector calculator 141, a vector average calculator 145 for calculating an average of vectors inside and/or outside an ROI (hereinafter referred to as an ROI inside/outside vector average calculator 145), and an image synthesizer 142. The ROI data accumulator 150 may also be included in the data accumulator 130. The processor 148 of the signal processor 140 constitutes an ROI setting unit.

The processor 148 sets an ROI 151 including an object of interest based on a subframe image 710. By using a supervised neural network model trained with combinations of subframe images 710 and ROIs 151 as training data, the ROI 151 may be extracted from the subframe image 710, and the extracted ROI 151 may be set. The processor 148 may also extract the ROI 151 by using a background subtraction method or the like, and set the extracted ROI 151.

The ROI data accumulator 150 generates an image within an ROI 151 by accumulating, over a plurality of unit exposure times, count values per unit exposure time for the ROI 151, which is preset as a coordinate region in image data among image regions of the image data. Because the ROI 151 is a coordinate region, it is also a coordinate region of the subframe image 710 and a coordinate region of the frame image 700. Hereinafter, for the sake of description, a case where the ROI 151 is set for a non-reference subframe image is described as an example.

The image generated within the ROI 151 corresponds to image data obtained by extracting data within the ROI 151 from the subframe image 710.

The difference vector calculator 141 may calculate the difference vectors 750 inside the ROI 151, based on the image within the ROI 151. The difference vectors 750 may be calculated based on an image within an ROI of a reference subframe image and an image within an ROI of each non-reference subframe image, by using the method same as or similar in some respects to the method used to calculate the difference vectors 750 from the subframe images 710 in the first example embodiment. The difference vector calculator 141 calculates the difference vectors 750 for each image within an ROI of a non-reference subframe image.

The difference vector calculator 141 also calculates the difference vectors 750 from the subframe image 710 as in the first example embodiment.

The ROI inside/outside vector average calculator 145 calculates, for each image within an ROI of a non-reference subframe image, an average of the difference vectors 750 inside the ROI 151. The ROI inside/outside vector average calculator 145 also calculates an average of the difference vectors 750 outside the ROI 151.

The ROI inside/outside vector average calculator 145 changes a subframe rate of the pixels 200 of the image within the ROI 151 by outputting an ROI-inside subframe rate change control signal to the ROI data accumulator 150. The ROI inside/outside vector average calculator 145 also changes a subframe rate of the pixels 200 outside the ROI 151 by outputting an ROI-outside subframe rate change control signal to the data accumulator 130.

In some example embodiments, based on the difference vectors 750 corresponding to the pixels 200 inside the ROI 151, the ROI inside/outside vector average calculator 145 controls a subframe rate of the ROI 151 by outputting an ROI-inside subframe rate change control signal. In some example embodiments, when an average magnitude of the difference vectors 750 corresponding to the pixels 200 inside the ROI 151 is greater than a predetermined fifth threshold value, the ROI inside/outside vector average calculator 145 increases the subframe rate for the pixels 200 inside the ROI 151. When the average magnitude of the difference vectors 750 corresponding to the pixels 200 inside the ROI 151 is less than or equal to the fifth threshold value, the ROI inside/outside vector average calculator 145 maintains the subframe rate at a base subframe rate.

According to some example embodiments, based on the difference vectors 750 corresponding to the pixels 200 outside the ROI 151, the ROI inside/outside vector average calculator 145 controls a subframe rate for the pixels 200 outside the ROI 151 by outputting an ROI-outside subframe rate change control signal. In some example embodiments, when an average magnitude of the difference vectors 750 corresponding to the pixels 200 outside the ROI 151 is less than a sixth threshold value, the ROI inside/outside vector average calculator 145 decreases the subframe rate for the pixels 200 outside the ROI 151. On the other hand, when the average magnitude of the difference vectors 750 corresponding to the pixels 200 outside the ROI 151 is greater than or equal to the sixth threshold value, the subframe rate may be maintained at the base subframe rate.

In the above example, the average magnitudes of the difference vectors 750 inside and outside the ROI 151 are used, but median values may also be used.

The fifth threshold value and the sixth threshold value may be set to appropriate values through experiments from the viewpoint of suppressing or reducing motion blur or the like.

The image synthesizer 142 corrects each pixel 200 inside the ROI 151 of a non-reference subframe image based on an average of the difference vectors 750 inside the ROI 151. The image synthesizer 142 corrects each pixel 200 outside the ROI 151 of a non-reference subframe image based on an average of the difference vectors 750 outside the ROI 151. The image synthesizer 142 generates a frame image 700 by adding the corrected non-reference subframe image to the reference subframe image.

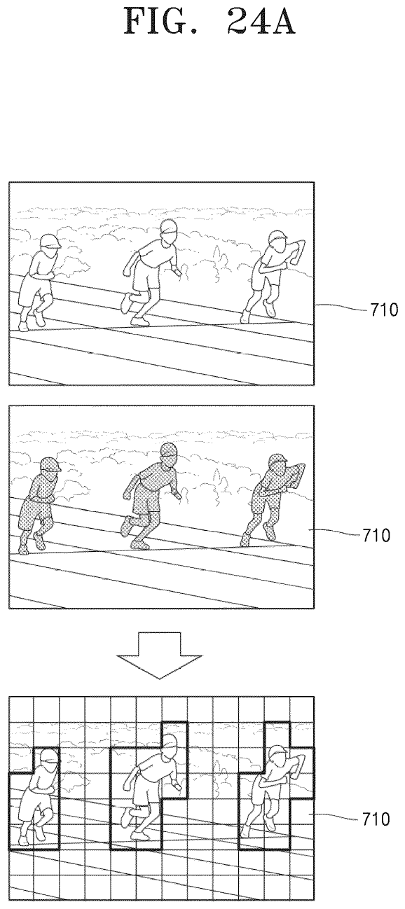

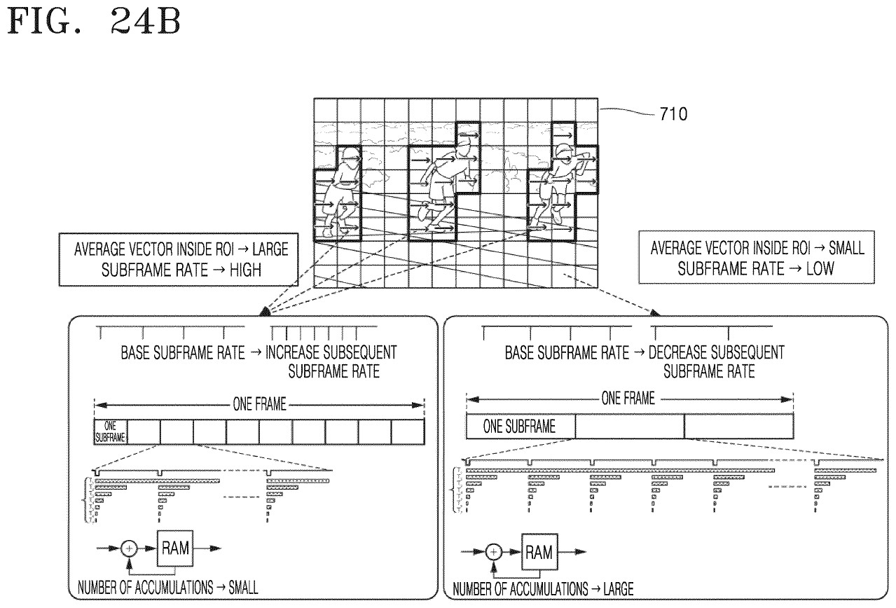

FIG. 24A illustrates estimation of the ROI 151, according to some example embodiments. FIG. 24B illustrates control of a subframe rate based on the difference vectors 750 corresponding to pixels 200 inside the ROI 151.

Objects of interest indicated in gray in a middle diagram are extracted from a subframe image 710 shown in an upper diagram of FIG. 24A, for example, by using a trained neural network model or other techniques. The objects of interest may be moving objects. The moving objects include a person. The ROI 151, shown as a region enclosed by thick lines in a lower diagram of FIG. 24A, is set as a region surrounding the objects of interest.

In the example shown in FIG. 24B, when an average magnitude of the difference vectors 750 corresponding to the pixels 200 inside the ROI 151 is greater than the fifth threshold value, a subframe rate for the pixels 200 inside the ROI 151 is increased. On the other hand, when the average magnitude of the difference vectors 750 corresponding to the pixels 200 inside the ROI 151 is less than or equal to the fifth threshold value, the subframe rate for the pixels 200 inside the ROI 151 is maintained at the base subframe rate.

In addition, when an average magnitude of the difference vectors 750 corresponding to the pixels 200 outside the ROI 151 is less than the sixth threshold value, the subframe rate for the pixels 200 outside the ROI 151 is decreased. On the other hand, when the average magnitude of the difference vectors 750 corresponding to the pixels 200 outside the ROI 151 is greater than or equal to the sixth threshold value, the subframe rate for the pixels 200 outside the ROI 151 is maintained at the base subframe rate.

In the above example, the average magnitudes of the difference vectors 750 inside and outside the ROI 151 are used, but median values may also be used.

Furthermore, although the difference vectors 750 are shown only within the ROI 151 in FIG. 24B, the difference vectors 750 may also be calculated outside the ROI 151.

Through the above process, it is possible to improve motion blur correction accuracy by increasing the subframe rate of the ROI 151 including a moving object moving at a relatively high speed and having a high likelihood of motion blur, while simultaneously suppressing or reducing an increase in power consumption by decreasing the subframe rate outside the ROI 151.

Hereinafter, a seventh example embodiment is described. The difference between the seventh example embodiment and the first example embodiment is as follows. In the first example embodiment, a region where the difference vector 750 is not calculated is not set. On the other hand, in the seventh example embodiment, the difference vectors 750 corresponding to low-luminance pixels are not calculated. In other respects, the seventh example embodiment is the same as or similar in some respects to the first embodiment, and thus repeated descriptions are omitted or simplified.

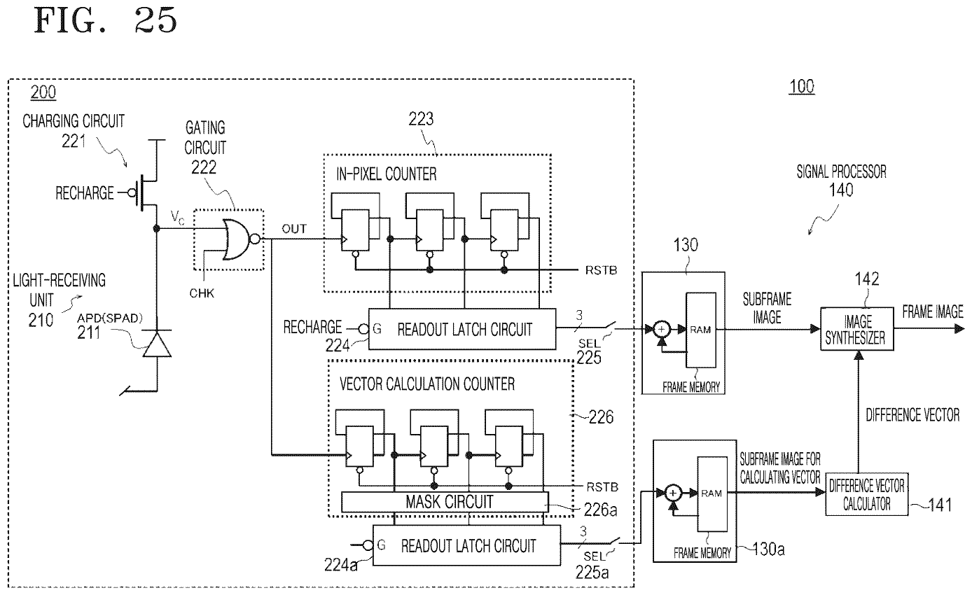

FIG. 25 is a schematic block diagram illustrating a configuration of an image sensor 100, according to some example embodiments.

Compared to the configuration of the first example embodiment, the pixel 200 further includes a vector calculation counter 226, a readout latch circuit 224a, and a SEL 225a. In addition, the image sensor 100 further includes a data accumulator 130a.

The vector calculation counter 226 includes a ripple counter having a 3-bit counter, similar to the in-pixel counter 223, and further includes a mask circuit 226a. When a count value of the ripple counter is small, the mask circuit 226a masks the count value and outputs the count value as 0. In some example embodiments, when the count value of the ripple counter is less than or equal to a predetermined or desired value, the count value is output as 0. The predetermined or desired value may be appropriately set through experiments or the like based on the quality of the frame image 700. The predetermined or desired value is, for example, 1. The predetermined or desired value may also be 2. Hereinafter, for the sake of description, a case in which the predetermined or desired value is 1 is described as an example. Accordingly, by not using low-reliability difference vectors 750 calculated from low-luminance pixels 200 for correction of a non-reference subframe image, the correction accuracy of the non-reference subframe image used to generate the frame image 700 may be improved. In some example embodiments, in the case of pixels 200 where photons are measured only in a sensitivity channel T₁, there is a possibility that the difference vectors 750 may be calculated without sufficiently obtaining a contrast difference. Therefore, the configuration enables the use of only high-reliability difference vectors 750 for correction of the non-reference subframe image by not using the difference vectors 750 calculated from such pixels 200, while achieving a high-speed subframe rate output. The mask circuit 226a may be configured using a known circuit.

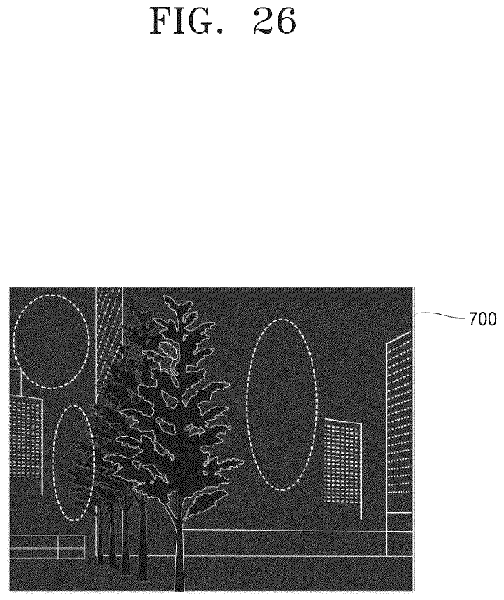

FIG. 26 is a diagram illustrating an example of the frame image 700 captured at night or in low light conditions. Areas enclosed by dashed circles in FIG. 26 represent areas of low-luminance pixels having low luminance.

As shown in FIG. 26, in the areas of the low-luminance pixels, there is an increased likelihood that a contrast difference cannot be sufficiently obtained. Therefore, the difference vectors 750 calculated from the low-luminance pixels may have low reliability.

The readout latch circuit 224a (FIG. 25) may be configured using the same circuit as the readout latch circuit 224 and output image data in which a pixel value of a low-luminance pixel is 0. In addition, a pixel value of a pixel 200 in which photons are not measured in any sensitivity channel is 0.

The SEL 225a (FIG. 25) may be turned on/off at the same timing as the SEL 225 by the same signal as a SEL signal that controls an on/off state of the SEL 225.

The data accumulator 130a may be configured with the same or similar circuit as the data accumulator 130. The data accumulator 130a generates a subframe image for vector calculation based on image data in which pixel values of low-luminance pixels are 0. The subframe image for vector calculation is a subframe image 710 used to calculate the difference vectors 750.

The difference vector calculator 141 calculates the difference vectors 750 based on the subframe image for vector calculation.

The image synthesizer 142 may generate a frame image 700 based on the subframe image 710 and the difference vectors 750.

According to some example embodiments, an anode 2112 or a cathode 2111 of an APD is recharged once per unit exposure time, a pulse signal is generated based on an output of an APD at a predetermined or desired timing within the unit exposure time, and an intermediate image is generated by accumulating, over a plurality of unit exposure times, values obtained by counting the pulse signal. Then, by using one of a plurality of intermediate images generated in a time series as a reference intermediate image, a difference vector for each pixel with respect to the reference intermediate image is calculated for each of at least one non-reference intermediate image other than the reference intermediate image, and a frame image is generated by adding, to the reference intermediate image, the at least one non-reference intermediate image corrected based on the corresponding difference vectors. Accordingly, an effect of suppressing or reducing motion blur of an image captured using a SPAD may be improved regardless of the speed of a moving object being captured.

According to some example embodiments, when the magnitude of the difference vectors is greater than a predetermined or desired first threshold value, a frame rate of the intermediate image is increased, and when the magnitude of the difference vectors is less than a predetermined or desired second threshold value, the frame rate of the intermediate image is decreased. Accordingly, an effect of reducing motion blur in an image of a high-speed moving object may be improved, and system costs such as power consumption and/or processing time may be suppressed or reduced.

According to some example embodiments, when at least one of the number and density of difference vectors having periodicity is greater than a predetermined or desired threshold value, the frame rate of the intermediate image is increased, and when the at least one of the number and density of difference vectors having the periodicity is less than a predetermined or desired threshold value, the frame rate of the intermediate image is decreased. Accordingly, an effect of reducing motion blur in an image of an object having periodicity or a high-density object may be improved, and system costs such as power consumption and/or processing time may be suppressed or reduced.

According to some example embodiments, the frame rate of the intermediate image is controlled based on difference vectors corresponding to pixels inside one or more ROIs in the intermediate image. Accordingly, processing costs for calculating the difference vectors may be reduced.

According to some example embodiments, one or more ROIs are set in the intermediate image, and a subframe rate for the pixels inside the one or more ROIs or a subframe rate for the pixels outside the one or more ROIs is changed based on the difference vectors respectively corresponding to pixels inside and outside the one or more ROIs in the intermediate image. Accordingly, motion blur correction accuracy may be improved by increasing the subframe rate of the ROIs including a moving object that moves at a relatively high speed and has a high likelihood of motion blur, and an increase in power consumption may be suppressed or reduced by decreasing the subframe rate outside the ROIs.

According to some example embodiments, the difference vectors corresponding to the pixels inside one or more ROIs in the intermediate image are calculated, and a frame image is generated by adding, to the reference intermediate image, the at least one non-reference intermediate image corrected based on the difference vectors. Accordingly, processing costs for calculating the difference vectors may be reduced.

According to some example embodiments, a low-luminance pixel having low luminance among pixels of the reference image is identified based on a pulse signal from a gating unit that generates the pulse signal based on the output of the APD at a plurality of timings within the unit exposure time, and a difference vector corresponding to the low-luminance pixel is not calculated. Accordingly, by not using the difference vector having low reliability calculated from the low-luminance pixel for correction of a non-reference subframe image, correction accuracy of the non-reference subframe image used to generate the frame image may be improved.

According to some example embodiments, the gating unit that generates the pulse signal by receiving the output of the APD and an input of determination signals at the plurality of timings is used. Accordingly, an effect of suppressing or reducing motion blur in an image captured using a SPAD may be improved with relative ease and with a relatively simpler configuration, regardless of the speed of a moving object being captured.

According to some example embodiments, a plurality of virtual sensitivity channels having different time lengths within the unit exposure time are provided, wherein any one of the plurality of virtual sensitivity channels is configured to include another virtual sensitivity channel on a time axis. Accordingly, an effect of suppressing or reducing motion blur in an image captured using a SPAD may be improved with relative ease and with a relatively simpler configuration, regardless of the speed of a moving object being captured.

According to some example embodiments, a method of operating an image sensor includes recharging an anode or a cathode of an avalanche photodiode of the image sensor once per unit exposure time; generating a pulse signal based on an output of the avalanche photodiode at a plurality of timings within the unit exposure time; counting the pulse signal; generating a plurality of intermediate images by accumulating, over a plurality of unit exposure times, values obtained by counting the pulse signal; and calculating, using an intermediate image of the plurality of intermediate images generated in a time series as a reference intermediate image, a difference vector for each pixel with respect to the reference intermediate image for each of at least one non-reference intermediate image other than the reference intermediate image, and generating a frame image by adding, to the reference intermediate image, the at least one non-reference intermediate image corrected based on difference vectors corresponding to each pixel.

According to some example embodiments, the method further includes in response to a magnitude of the difference vectors being greater than a first threshold value, increasing a frame rate of the intermediate image, and in response to the magnitude of the difference vectors being less than a second threshold value, decreasing the frame rate of the intermediate image.

According to some example embodiments, the method further includes in response to at least one of a number of the difference vectors having periodicity or a density of the difference vectors being greater than a first threshold value, increasing a frame rate of the intermediate image, and in response to at least one of the number of the difference vectors having periodicity or the density of the difference vectors being less than a second threshold value, decreasing the frame rate of the intermediate image.

According to some example embodiments, the method further includes controlling the frame rate of the intermediate image based on the difference vectors corresponding to pixels inside one or more regions of interest (ROIs) in the intermediate image.

According to some example embodiments, the method further includes calculating the difference vectors corresponding to pixels inside one or more ROIs in the intermediate image, and generating the frame image by adding, to the reference intermediate image, the at least one non-reference intermediate image corrected based on the difference vectors.

As described herein, any devices, systems, modules, portions, units, controllers, circuits, and/or portions thereof according to any of the example embodiments, and/or any portions thereof (including, without limitation, the controller 110, the pixel array 120, the data accumulator 130, the signal processor 140, the ROI data accumulator 150, the light-receiving unit 210, the pixel circuit 220, the gating circuit 222, the in-pixel counter 223, the readout latch circuit 224, the selection circuit 225, the difference vector calculator 141, the image synthesizer 142, the vector average calculator 143, the processor 148, the memory 149, the vector average calculator 145, the vector calculation counter 226, the readout latch circuit 224a, the selection circuit 225a, the mask circuit 226a, any portion thereof, or the like) may include, may be included in, and/or may be implemented by one or more instances of processing circuitry such as hardware including logic circuits; a hardware/software combination such as a processor executing software; or a combination thereof. For example, the processing circuitry may more specifically include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, an application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

While the disclosure has been particularly shown and described with reference to example embodiments thereof, it will be understood that various changes in form and details may be made therein without departing from the spirit and scope of the following claims.

What is claimed is:

1. An image sensor comprising:
an avalanche photodiode including an anode and a cathode;
a charging circuit configured to recharge the anode or the cathode once per unit exposure time;
a gating circuit configured to generate a pulse signal based on an output of the avalanche photodiode at a plurality of timings within the unit exposure time;
an in-pixel counter configured to count the pulse signal;
an intermediate image generator configured to generate a plurality of intermediate images by accumulating, over a plurality of unit exposure times, values counted by the in-pixel counter; and
a frame image generator configured to calculate, by using an intermediate image of the plurality of intermediate images generated in a time series as a reference intermediate image, a difference vector for each pixel with respect to the reference intermediate image for each of at least one non-reference intermediate image other than the reference intermediate image, and generate a frame image by adding, to the reference intermediate image, the at least one non-reference intermediate image corrected based on difference vectors corresponding to each pixel.

2. The image sensor of claim 1, further comprising:
a processor configured to, in response to a magnitude of the difference vectors being greater than a first threshold value, increase a frame rate of the intermediate image, and
in response to the magnitude of the difference vectors being less than a second threshold value, decrease the frame rate of the intermediate image.

3. The image sensor of claim 1, further comprising:
a processor configured to, in response to at least one of a number of the difference vectors having periodicity or a density of the difference vectors being greater than a first threshold value, increase a frame rate of the intermediate image, and
in response to at least one of the number of the difference vectors having periodicity or the density of the difference vectors being less than a second threshold value, decrease the frame rate of the intermediate image.

4. The image sensor of claim 2, wherein the processor is further configured to control the frame rate of the intermediate image based on the difference vectors corresponding to pixels inside one or more regions of interest (ROIs) in the intermediate image.

5. The image sensor of claim 2, further comprising:
an ROI setting unit configured to set one or more ROIs in the intermediate image,
wherein the processor is further configured to change a subframe rate inside the one or more ROIs or a subframe rate outside the one or more ROIs based on the difference vectors respectively corresponding to pixels inside and outside the one or more ROIs in the intermediate image.

6. The image sensor of claim 1, wherein the frame image generator is configured to calculate the difference vectors corresponding to pixels inside one or more ROIs in the intermediate image, and generate the frame image by adding, to the reference intermediate image, the at least one non-reference intermediate image corrected based on the difference vectors.

7. The image sensor of claim 1, wherein the frame image generator is configured to identify a low-luminance pixel having low luminance among a plurality of pixels of the intermediate image, based on the pulse signal that is output from the gating circuit, and to not calculate the difference vector corresponding to the low-luminance pixel.

8. The image sensor of claim 1, wherein the gating circuit is configured to generate the pulse signal based on the output of the avalanche photodiode and an input of determination signals at the plurality of timings.

9. The image sensor of claim 1, wherein the unit exposure time includes a plurality of virtual sensitivity channels having different time lengths, and
the plurality of virtual sensitivity channels are configured such that one of the plurality of virtual sensitivity channels includes another virtual sensitivity channel on a time axis.

10. An image sensor comprising:
a pixel array including a plurality of pixels each including an avalanche photodiode;
a data accumulator configured to generate a plurality of subframe images including a first subframe image and a second subframe image by accumulating count values of pixel data from the pixel array for each unit exposure time; and
a signal processor configured to generate a frame image by processing the plurality of subframe images,
wherein the signal processor is configured to,
calculate difference vectors for the second subframe image with respect to the first subframe image as a reference, and
generate a corrected second subframe image by applying the difference vectors to the second subframe image, and generate the frame image by adding the corrected second subframe image to the first subframe image.

11. The image sensor of claim 10, wherein the signal processor is further configured to calculate the difference vectors for each of the plurality of pixels with respect to the first subframe image as the reference.

12. The image sensor of claim 10, wherein the signal processor is further configured to calculate the difference vectors only within a region of interest (ROI) that is a partial region of the second subframe image.

13. The image sensor of claim 10, wherein the signal processor is further configured to determine an increase or a decrease in a subsequent subframe rate based on a result of comparing a parameter related to the difference vectors with a threshold value.

14. The image sensor of claim 13, wherein the parameter related to the difference vectors includes at least one of an average value of a magnitude distribution of the difference vectors and a median value of the magnitude distribution of the difference vectors.

15. The image sensor of claim 13, wherein the parameter related to the difference vectors includes at least one of a number of the difference vectors having periodicity and a density of the difference vectors.

16. The image sensor of claim 10, wherein
the signal processor is further configured to,
based on dividing the second subframe image into a first region and a second region, calculate difference vectors for each of the first region and the second region, and
control a subframe rate of the first region and a subframe rate of the second region differently from each other based on the difference vectors.

17. An image sensor comprising:
a pixel array comprising a light-receiving unit including an avalanche photodiode, and a pixel circuit;
a data accumulator configured to generate a plurality of subframe images by accumulating count values of pixel data from the pixel array for each unit exposure time; and
a signal processor configured to generate a frame image by processing the plurality of subframe images,
wherein the signal processor is configured to determine an increase or a decrease in a subsequent subframe rate based on a parameter related to difference vectors calculated by comparison between some of the plurality of subframe images.

18. The image sensor of claim 17, wherein the parameter related to the difference vectors includes at least one of an average value of a magnitude distribution of the difference vectors and a median value of the magnitude distribution of the difference vectors.

19. The image sensor of claim 17, wherein the parameter related to the difference vectors includes at least one of a number of the difference vectors having periodicity or a density of the difference vectors.

20. The image sensor of claim 17, wherein
the signal processor is configured to,
compare the parameter related to the difference vectors with a threshold value, and increase the subsequent subframe rate in response to the parameter being greater than the threshold value, and
decrease the subsequent subframe rate in response to the parameter being less than the threshold value.
